(19) United States
(12) Patent Application Publication
(10) Pub. No.: US 2004/0143602 A1
(43) Pub. Date: Jul. 22, 2004

(54) Apparatus, system and method for automated and adaptive digital image/video surveillance for events and configurations using a rich multimedia relational database

(76) Inventors: Antonio Ruiz, Poughquaq, NY (US); John Vance Meyers, Edgewater, MD (US)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 10/686,578

(22) Filed: Oct. 17, 2003

Related U.S. Application Data
(60) Provisional application No. 60/419,788, filed on Oct. 18, 2002.

(51) Int. Cl. G06F 7/00

(52) U.S. Cl. 707/104.1

(57) ABSTRACT

An automated and adaptive digital image/video and/or sensor surveillance system is provided in a massively and pervasively deployed sensor/image surveillance environment using virtual configuration perimeters for all the subsystems and processes which allow triggered events to be automatically captured by virtual event perimeters in environments where unattended operation and automatic support needs to be provided for real-time event analysis, automatic event tracking, or for storage and retrieval of sensory or visual event information within the scope of the large scale spatio-temporal domain of a target surveillance environment. All operations are performed in the framework of the captured data, information, and knowledge derived through fusion operations and captured in a relational surveillance database subsystem. The information collected and derived knowledge may be used to dynamically create new virtual event perimeters and new virtual configuration perimeters to enable the system to learn and adapt to events as they take place.

### CROSS-REFERENCES TO RELATED APPLICATIONS

This application claims the benefit of U.S. Provisional Patent Application No. 60/419,788, filed Oct. 18, 2002.

### BACKGROUND OF THE INVENTION

1. Field of the Invention

This invention relates to surveillance systems, and, more particularly, to automated and adaptive surveillance systems that manage the configuration and operation of all subsystems; automatically analyze video data, digital image data, and sensor information in a spatio-temporal framework of a target surveillance environment; automatically adapt to events in a pre-configured manner; and provide simplified data and information to human decision makers.

2. Description of the Related Art

The use of video surveillance systems has been extensive and has evolved over the years to include digital video and digital imaging. The use of digital imaging storage has also evolved into digital video recording (DVR) systems for storing multiple video streams coming from multiple camera and sensor feeds. At the same time that video surveillance has evolved, the use of sensors of different kinds to sense activity, changes, and other parameters pertinent to the environment under surveillance has evolved to incorporate many different kinds of sensors and sensing modes. As both video surveillance devices and other sensors have become digital and they both have multiple wired and wireless communications options available, it has become necessary to augment the two areas with a completely automated and adaptive system that goes beyond simple real-time monitoring capability to provide automatic alerting, decision support, and response in surveillance systems.

Additionally, relational database systems have now become standard products and are offered in many environments with application tools, operands, and operations to relate multiple data, information, and knowledge parameters according to many categories and search criteria. All of these systems take advantage of pervasive processing and communications that enable smarter configurable sensor units, faster control for cameras, real-time encoding and decoding of digital video, immediate transmission for real-time monitoring or storage, immediate transmission during a retrieval operation, and multiple graphical user interfaces (GUIs) to perform configurations and make easy use of the resulting information and knowledge. The method discussed here proposes an automatic and adaptive system, with profiles, that operates on real-time data and a surveillance relational database system.

The prior art provides several piecewise elements of systems for digital video surveillance augmented by many other elements that are used independently and separately in the current practice. Numerous patents have issued for various surveillance and video-data-manipulation systems. Assorted such apparatuses, systems and methods are described by the following documents, each of which is incorporated herein by reference in its entirety: U.S. Pat. No.'s: 4,081,830; 4,875,912; 5,151,945; 5,485,611; 5,689,442; 5,745,126; 5,862,342; 5,875,304; 5,875,305; 5,884,042; 5,909,548; 5,917,958; 5,969,755; 5,974,235; 5,982,418; 6,049,363; 6,069,655; 6,097,429; 6,144,375; 6,144,797; 6,166,735; 6,182,069; 6,281,790; 6,292,215; 6,330,025; 6,356,658; 6,353,678; 6,411,209; 6,424,370; 6,437,819; 6,462,774; 6,476,858; 6,559,769; 6,570,496; 6,570,608; 6,573,907; 6,583,813; 6,587,574; 6,587,779; 6,591,006; 6,608,559.

While the above-listed patents and known surveillance systems represent important innovations, every conventional attempt at automatic surveillance systems endeavors to create a vertical solution that can only be applied to one surveillance environment application. Accordingly, there is a need for an end-to-end system that can be integrated for any environment or combination of environments by marrying together the same method and system framework under the same hierarchical architecture, same layered design, same data and applet or agent structures, same family of utility layer algorithms from known physical layer elements, same family of spatio-temporal abstraction layer processes in the surveillance environment, same application layer applications, and same virtual configuration perimeter and virtual event perimeter constructions customized for each surveillance environment. There further exists a need for a very powerful solution integration tool for automated and adaptive surveillance applications for large scale and diverse applications where the framework is one and the same, while the customizable pieces are readily configurable using standard open system tools.

The prior art discusses elements and sub-elements that can be used as implementations, pieces, and partial subsystems of a complete system that embodies an apparatus, method and system of this invention for automatic and adaptive surveillance in multiple environments. For example, while some prior systems describe adaptive systems, and others describe a computed field of view (FOV) system, such known systems assume that the camera systems are driven using manual pan-tilt-zoom (PTZ) controls, and FOVs and objects are tracked as the same subject cameras are changed continuously in response to single or multiple events. Accordingly, there exists a need for surveillance systems that do not require continuously changing camera system parameters but instead are based on quasi-static, highly pervasive and massively deployed full coverage surveillance systems where the utility layers and the abstraction layers can score each of their respective algorithms in a localized and distributed implementation. There further exists a need for fully automated single or multiple event tracking in the true sense of the spatio-temporal domain of not just one camera/sensor, or a few co-located cameras/sensors with changing settings, but the global spatio-temporal space of the complete surveillance environment comprising a whole and complete set of available full coverage camera systems/sensor systems within the space of virtual configuration parameter and virtual event parameter configurations that can dynamically evolve with the event and can operate at the algorithmic sensing level, the global multi-camera/sensor and multi-location space of spatio-temporal abstractions, and the application level analysis applications of different kinds, to perform real-time, concurrent, and knowledge building analysis for automatic response or end-user decision support.

### BRIEF SUMMARY OF THE INVENTION

In a first aspect, the invention is directed to automated and adaptive video/image and sensor surveillance systems that manage the configuration of all subsystems and automatically analyze video/image frames or sensor information in a spatio-temporal framework comprised of massively and pervasively deployed multiple camera systems, multiple sensor systems, distributed processing subsystems integrated with or near cameras or sensors systems, distributed storage integrated with or near cameras or sensor systems, wireless or wired networking communications subsystems, single or multiple remotely located distributed server systems, single or multiple remotely located distributed storage systems, single or multiple remotely located distributed archival systems, single or multiple remotely located end-user operator systems, and graphical user interfaces to operate this automated and adaptive digital video/image/sensor surveillance system.

The invention further relates to the creation of an automated system for video/image or sensor surveillance where real-time information from the video/image frames or sensor readings is processed in real-time and non-real-time to perform pre-configured multiple step real-time and non-real-time analysis of the multimedia rich information originating in this system and captured as part of the distributed video/sensor relational database to provide specifically configured data fusion into information, and information fusion into knowledge, using algorithms and processes operating on the multimedia rich data and database information in real-time and offline to arrive at decision support and “event” alert support to end-user operators of said system. The configurations lead to causal events which can be recursively used to automatically generate new dynamic configurations based on the previous cascading events that occur in a multi-location surveillance environment with full global spatio-temporal considerations as defined by the predefined and dynamically generated automatic and adaptive configurations. To achieve this we take advantage of available data structures, executable applets or agents and application techniques of the trade which can define rules, software, programs, data structures, metadata definitions, rules, languages, and functional relationships among these that are described using such design languages as UML (Unified Modeling Language) and other markup languages suitable for this class of systems.

The invention takes advantage of massively and pervasively deployed video/image cameras and/or sensors with distributed processing and database subsystems in programmable configurations. The invention assumes that the whole spectrum of sensor and image coverage in the deployment space and within the performance features of the system are fully available to perform automatic and adaptive surveillance operations. The configurations of the physical layer subsystems, utility layer subsystems, abstraction layer subsystems, application layer subsystems, and management and control layer subsystems are established a-priori or they can be configured with data structures and applets or agents in the distributed system so that they can be dynamic and can respond automatically or with minimal configuration parameters to changing event conditions as manifested in the real-time or non-real-time analysis (also referred to as a trend analysis).

The apparatus, method and system for automated and adaptive digital image/video and sensor surveillance makes use of all data and information means available in any given environment to provide a superior decision support tool for the purposes of visual and sensor surveillance associated with events. The events are triggered on virtual event perimeters based on the profiles configured by virtual configuration perimeters that control the operation of static and dynamic settings in the multi-layered processes of a distributed system.

We take a systematic approach that considers each part of the total system and structures a complete solution that can be taken partially, or in whole, as required by multiple application environments and multiple preferred embodiments of the invention as described below. The system for this solution is comprised of five key layer components as follows:

1) PHYSICAL LAYER: The physical layer for this system comprises all the camera systems, sensor systems, integrated camera and sensor systems, PTZ (Pant-Tilt-Zoom) controls for cameras and sensors, controls for camera imaging modes, and controls for sensor thresholds. The physical layer also comprises the system physical settings and system controls such as the digital video storage and retrieval system, the network of camera systems, and the network of sensor systems.

2) UTILITY LAYER: The utility layer of the solution comprises all the detection, recognition, and identification operations of the system as performed by the sensors, sensor fusion applications, video image processing and sensor interaction, and frame to frame image processing. The utility layer also controls the storage and retrieval of raw information from the Relational Surveillance Database (RSDS) of the system.

3) ABSTRACTION LAYER: The abstraction layer of the system is where the operations of the Utility Layer are further discerned, full location and spatio-temporal abstractions occur and are turned into specific types of identifications, such as those of critical event importance, such as: human activity, vehicle activity, vessel activity, human/vehicle interaction activity, human/vessel interaction activity, and the like. Furthermore, the abstraction layer also performs the operations of Learning, Categorizing, Comparing, Discarding, Alerting, Non-Alerting, and Requesting Manual Operation and Response.

4) APPLICATION LAYER: The application layer of the system contains all applications that interface to the end-users of the system and includes all user interfaces, including GUIs, for any and all aspects of performing the operations associated with configuring and running an automated activity video surveillance system. The application layer begins by allowing the full configuration of all the previous layers (Physical, Utility, and Abstraction) using the Management/Control Layer (as described in the next paragraph). Furthermore, the Application Layer provides the full interface to the automated, manual, and “critical event” alert and response resulting from the automated activity identification. The Application Layer also contains the processes (e.g., trend analysis, data mining) by which the identification learning will store new identifications and retrieve existing identification profiles for comparison with ongoing identifications using the results of the Utility Layer and Abstraction Layer processes.

5) MANAGEMENT/CONTROL LAYER: The management and control layer accounts for all configurations of the available digital video surveillance environment which includes the activity detection/recognition/identification processes, the spatio-temporal parameters configurations, the physical and utility layer controls that determine the use of all physical and logical assets of the system (e.g., camera systems, sensor systems, digital storage systems, etc.), and the Abstraction Layer Configuration Parameters. Since the Management/Control Layer is the only Layer that interfaces to all other Layers, it is directly responsible for setup and management of the assets of all Layers and their associated systems and operations.

Accordingly, the present invention takes advantage of the prior art and the currently evolving open-system and open-standard physical assets as in our physical layer, algorithms as in the utility layers, processes as in the abstraction layer, applications as in the application layer, distributed relational databases as in the RSDS, open wireless and wired networking communications, distributed processors, operating systems, standard GUIs, open-system data structures, open-system applets or agents, and open-system program interfaces to converge on the method and system of this invention. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1a illustrates multi-layered processes of the method and system of the invention;

FIG. 1b illustrates constitution of the Physical layer 101;

FIG. 1c illustrates constitution of the Utility layer 102;

FIG. 1d illustrates constitution of the Abstraction layer 103;

FIG. 1e illustrates constitution of the Application layer 104;

FIG. 1f illustrates constitution of the Management/Control layer 105;

FIG. 2 illustrates elements and operations of the method and system of the invention;

FIG. 3a illustrates an example of a camera system and sensor system coverage over a physical location used as the building block for massively and pervasively deployed camera systems and sensors in a perimeter protection application environment;

FIG. 3b illustrates a further example of a camera system and sensor system coverage over a physical location used as the building block for massively and pervasively deployed camera systems and sensors in a perimeter protection application environment;

FIG. 3c illustrates yet a further example of a camera system and sensor system coverage over a physical location used as the building block for massively and pervasively deployed camera systems and sensors in a perimeter protection application environment;

FIG. 4a illustrates an example of vertical camera system and sensor system configurations for increased coverage in a VCP (Virtual Configuration Perimeter);

FIG. 4b illustrates a further example of vertical camera system and sensor system configurations for increased coverage in a VCP;

FIG. 5a illustrates sample data structures and applets or agents as used in the VCPs for the physical layer;

FIG. 5b illustrates sample data structures and applets or agents as used in the VCPs for the utility layer;

FIG. 5c illustrates sample data structures and applets or agents as used in the VCPs and VEPs (Virtual Event Perimeters) for the abstraction layer;

FIG. 5d illustrates sample data structures and applets or agents as used in the VCPs for the application layer;

FIG. 6a illustrates a method of VCP and VEP operations on the layered elements of the automated and adaptive surveillance system;

FIG. 6b illustrates the VEP management, generation, and alert operations of the automated and adaptive surveillance system;

FIG. 7a illustrates a hierarchical system embodiment example of the invention;

FIG. 7b illustrates a further hierarchical system embodiment example of the invention;

FIG. 8 illustrates an RSDS with its component elements comprising the spatio-temporal information contained in the surveillance system;

FIG. 9 illustrates a preferred embodiment of the invention for automated and adaptive human activity and human/vehicle activity surveillance system using VCPs and VEPs;

FIG. 10 illustrates an example of VCPs in a typical force protection installation facility;

FIG. 11 illustrates a preferred embodiment of the invention for an automated and adaptive human activity at night surveillance system in a predefined perimeter for infrastructure and force protection using VCPs and VEPs;

FIG. 12 illustrates a preferred embodiment of the invention for automated and adaptive video and/or multi-sensor surveillance system in trains and tunnels for terrorist attack and illegal activity protection using VCPs and VEPs and a combination of sensors and cameras;

FIG. 13 illustrates a sample configuration of an in-train-car networked sensor with wireless communications;

FIG. 14 illustrates a networked sensor configuration with wired and wireless communications inside a tunnel;

FIG. 15 illustrates a method and system design using multiple views and a wired and wireless network;

FIG. 16 illustrates a sample GUI for end-user application interface;

FIG. 17 illustrates a preferred embodiment of the invention for automated and adaptive video and/or multi-sensor surveillance system for terrorist threat infrastructure protection using VCPs and VEPs;

FIG. 18 illustrates an example of VCPs in a surveillance solution for a campus with public buildings;

FIG. 19 illustrates examples of multi-sensor system coverage using integrated sensors in a multiple building and campus environments;

FIG. 20 illustrates a sample network configuration for multiple integrated sensor surveillance system using a mixture of wired and wireless systems;

FIG. 21 illustrates a preferred embodiment of the invention for automated and adaptive vehicle tracking activity surveillance system using VCPs and VEPs;

FIG. 22 illustrates an example of a preferred embodiment of the invention for a vehicle activity surveillance system using VCPs and VEPs with a distributed processing and database implementation;

FIG. 23 illustrates a sample GUI for use in the example of vehicle activity surveillance system using VCPs and VEPs with a distributed processing and database implementation;

FIG. 24 illustrates examples of VCPs and VEPs for deployment in a city environment using massively deployed camera systems at key intersections;

FIG. 25 illustrates an example of views resulting from exercising first VEP in the preferred embodiment of crime surveillance or traffic surveillance example;

FIG. 26a illustrates an example of external VCPs in a building environment showing various camera and sensor system configurations;

FIG. 26b illustrates an example of internal VCPs in a building environment showing various camera and sensor system configurations;

FIG. 27 illustrates a VCP example for camera system platforms mounted on flying vehicles; and

FIG. 28 illustrates an example of a preferred embodiment of the invention for activity surveillance system using VCPs and VEPs with a distributed processing and database implementation using highly integrated, small, remotely-located footprint subsystems for force protection and infrastructure protection in military urban deployment applications.

### DETAILED DESCRIPTION OF THE INVENTION

In the following detailed description of the invention, reference is made to the accompanying drawings, which form a part of the disclosure, and, in which are shown by way of illustration, and not of limitation, specific embodiments by which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

The following definitions are deemed useful in understanding the present invention:

“Cameras and Camera Control”: one or more cameras are usually present in a surveillance system. In the preferred embodiments of this invention, we envision massively and pervasively deployed camera systems in the target surveillance area of interest and they are to be deployed in fixed locations or on moving or mobile platforms. The cameras can be of many different kinds and can provide various light or other visualization modes such as infrared, thermal, x-ray, ultraviolet, low-light, saturated, image intensification, or narrow spectrum renditions of the visualized space. Cameras can also incorporate one or more self-contained or remote digital image sensing capabilities that are part of the camera visualization system. Furthermore, camera control typically comes in the form or pan, tilt, zoom, focus, filters, microphone input(s), image visualization mode(s), etc. The cameras can be operated manually, locally, remotely, automatically, and then can be turned on and off or be placed online or offline based on side data such as sensor data and other parameters derived from the camera system itself (e.g., image visualization mode(s), sound, co-located sensors, remotely located sensors, or the like), or the end-to-end system as part of activating the virtual control perimeters (VCPs) to be defined later or the virtual event perimeters (VEPs) to be defined later in this invention.

“Camera Systems” describes any digital video surveillance camera or group of cameras (i.e., video, infrared (IR), image intensification (11), or the like) that are co-located or related to each other by coverage, by physical location, by other specific relation (e.g., being on the same wireless or wired network). “Camera systems” is also used to refer to camera clusters with sensors. We assume that most camera systems may have pan-tilt-zoom (PTZ) adjustments; however, it should also be noted that all cameras do not have to have PTZ capability. Additionally, we assume that the PTZ controls can be run automatically by the system in response to a new configuration parameter. Similarly, the automated control also extends to field adjustments, imaging modes, sensor mode adjustments, and the like.

“Sensor Systems” refers to any sensors located within the coverage of camera systems, co-located with camera systems, linked to camera systems, and/or in the vicinity of camera systems, or otherwise within the surveillance environment, to trigger a detection utility (as in Utility Layer), so that the system can perform other Utility Layer or Abstraction Layer operations.

“Sensor Data”: many different kinds of sensor data can be associated with the video, images, audio, location, and time data associated with the different kinds of imaging that are incorporated into the system data. For the purposes of this invention, sound will be considered part of sensor data even when associated with video/image data. Furthermore, the same data can be used to activate one or more cameras (or microphones, or other sensors) or change the physical asset control parameters. Sensor data can come from simple sensors co-located with a camera system or they can be remote sensors in stand-alone or networked configurations that have a communications capability. Once networked, the sensors are considered part of the process definitions.

“Integrated Camera and Sensor System” refers to integrated systems, which can be both co-located (e.g., a microphone on a camera) and non-co-located (e.g., a remote seismic sensor that turns on a camera, or a set of disposable sensors that activate cameras on an overhead UAV—Unmanned Air Vehicle—in a loitering pattern) with the capabilities of both video camera systems and sensor systems. With the benefits of the automated activity identification digital video/sensor surveillance system, we can afford to provide more extensive coverage of areas of interest, as will be described in more detail below.

“Surveillance devices” refers to any camera, sensor, integrated camera/sensor, or combination of cameras, sensors, or other devices used for gathering surveillance information in the surveillance system and method of the invention.

“Time”: all surveillance applications are related to a time and date stamp for when the image/video or sensor reading is taken. As a result of time-stamping on all image/video and sensor information, the time-stamping process and its management results in the practice of using a global clock synchronization scheme for all distributed processes of the system in all preferred embodiments of this invention.

“Space”: all surveillance applications of this invention are related to a location for the cameras, sensors, and the space coverage (usually called a field of view (FOV) or field of coverage (FOC)) of the camera and/or sensor system. All co-located physical layer assets associated with a location are labeled using standard techniques compatible with the distributed relational surveillance database implementation. Furthermore, related operational cameras, sensors, and networks of the same will be correspondingly identified when incorporating space location information related to the data processed, stored, received, and retrieved from the system. Similarly, when using algorithms that locate and/or track objects, an appropriate coordinate system is used in which all 2D or 3D information to locate data and information will be linked. Additionally, since some cameras or sensors could be located on mobile platforms such as vehicles, trains, or flying platforms, their location and navigational information is incorporated and linked into the appropriate data and information in the relational surveillance database.

“Digital Communications”: for purposes of this invention we deal with digital systems, including the digitization of analog video/images/sensor data, or the actual manipulation of digital video/images/sensor data resulting directly from camera systems or sensors. For this, the digital video, digital image, digital audio, and other digital data streams require a certain bandwidth of communications that must be guaranteed (either in communications or store and forward capability) for delivery in real-time or almost real-time to a viewing/receiving system and/or storage location. The system described herein has variable video stream rate capability or sensor data decimating capability resulting in varying degrees of video/image or sensor quality that can also be adjusted according to the level of precision required for the environment or the application (e.g., evidentiary quality associated with a particular event; lower quality associated with non-event viewing that can be changed to higher quality based on an event; running of both high quality and low-quality modes but discarding high-quality data when not required; and the like).

“Storage and Retrieval”: as part of this invention, we assume that all data will be stored in some form so that it can be used later or immediately by the layered processes of the system or end-user operator stations. Storage, retrieval, and processing of data in the database can happen simultaneously, and provides a “run-time continuum” of data and information, which can run concurrently with any real-time or offline process.

“Relational Surveillance Database” (RSDS): to better manage, label, store, and retrieve useful information from the embodied implementation of the system using the method of the invention, all of the data captured by the system is incorporated into a relational surveillance database where the video, the images, the sensor data (inclusive of any audio), the time, the space information, and the like, are all digested, organized, and stored in a relational database for use by the processes of the method herein or manually by any end-user application.

“Computing System(s)”: one or more centralized, distributed, or pervasive computing systems are included for the purpose of running the subsystem layers that embody the methods of the system.

“Multiple database fields”: a multiplicity of relational database fields inclusive of labeling information on video frames, image frames, sensor data readings, audio frames, multiple granularities of various time and space parameters (for decimation and interpolation applications), and other fields to facilitate the operations and the operands of the profiles of Virtual Configuration Perimeters (VCPs) and Virtual Event Perimeters (VEPs) as defined below.

“Virtual Configuration Perimeters” (VCPs): these are defined as the characterization operands for operating a digital video surveillance system with a-priori, dynamic, event driven, and other configurable parameters for the purposes of digital video surveillance system monitoring, recording, and analyzing visual, audio, sensor-based, and other parameters as part of a comprehensive relational database. The main objective of VCPs is the creation and specification of multiple layer processes configurations. VCPs are both static and dynamic; however, VCPs cannot generate other VCPs. Only VEPs can dynamically generate VCPs as is explained below. VCPs incorporate profiles comprised of data structures and applets or agents, which enable multiple layered processes to be configured and scheduled according to the operational characteristics of the system.

“Virtual Event Perimeters” (VEPs): these are defined as the characterization operands for searching or operating any particular “event” driven application or agent that is the object of the visual information or sensor-related information in the relational database. VEPs permit real-time, just-in-time, recent time, and after-the-fact operation and extraction of video/image and/or sensor data together with its related data as an information group for purposes of evaluation by a human operator or an automatic application operation such as algorithms for face recognition, license plate number recognition, feature extraction and matching, pattern recognition, or the like. The objective of the VEPs is to be able to define and refine real-time or offline search operations, real-time as well as offline data mining applications (e.g., data, feature extraction, sensor data based, image recognition, audio recognition, behavioral trend analysis, behavioral pattern analysis, etc.), and other applications can transform data into information and then further into knowledge for decision support of human operators or automated decision-making for generating automated responses (e.g., gate closures, release of mitigating agents, etc.). VEPs can be configured in real-time or based on specific parameter settings pertinent to the operational or information extraction application. VEPs can also generate other VCPs and VEPs as part of their functionality. VEPs incorporate profiles comprised of data structures and applets or agents that enable multiple layered processes to be configured and scheduled according to the operational characteristics of the system.

“Surveillance Profiles”: they come in two types, (1) operational profiles, as mainly used for Virtual Configuration Perimeters (VCPs) and (2) information extraction or operational profiles for Virtual Event Perimeters (VEPs). Profiles are not only operands but can implement application definitions (e.g., Java applets, applets, or agents).

“Operational Profiles for VCPs”: a set of parameters that can be used to operate the surveillance system using a multiplicity of parameters for operations and operands. Examples of the parameters may include any one instance or combination of the following:

Pan, tilt, and zoom (PTZ) configurations;

Sensor-based PTZ configurations;

Remote sensor data collection definitions;

Time parameters;

Sensor network data collection and data-triggering mechanisms;

Various modes of camera operations for video and image adjustment (e.g., contrast, brightness, contour enhancements, etc.);

Various types of video cameras (low-light, broad dynamic range, infrared, ultraviolet, etc.);

Various types of audio modes;

Various quality settings (e.g., high bandwidth, medium bandwidth, low bandwidth, high resolution frames, medium resolution frames, low resolution frames, high frame rate, medium frame rate, low frame rate, frame by frame, variable frame rates, variable resolution rates, MPEG-4, MPEG-2, JPEG, Wavelet, etc.); and

Multiple administrative or end-user access security level settings in pre-defined or dynamic modes.

“Information Extraction or Operation Profiles”: a set of parameters to search and obtain information from the database using a data mining operation or a “profile matching application” for purposes of extracting and presenting video or image information together with its associated relational database parameters. Additionally, VEPs can also be used to provide support for real-time operations where a VEP extends to incorporate a VCP and the two constructs work together to provide a continuum of recent information, real-time information, and future configurations as events develop or as required in mobile video or sensor surveillance platforms such as UAVs (Unmanned Air Vehicles), drones, robots, or manned vehicles on land, water, or air.

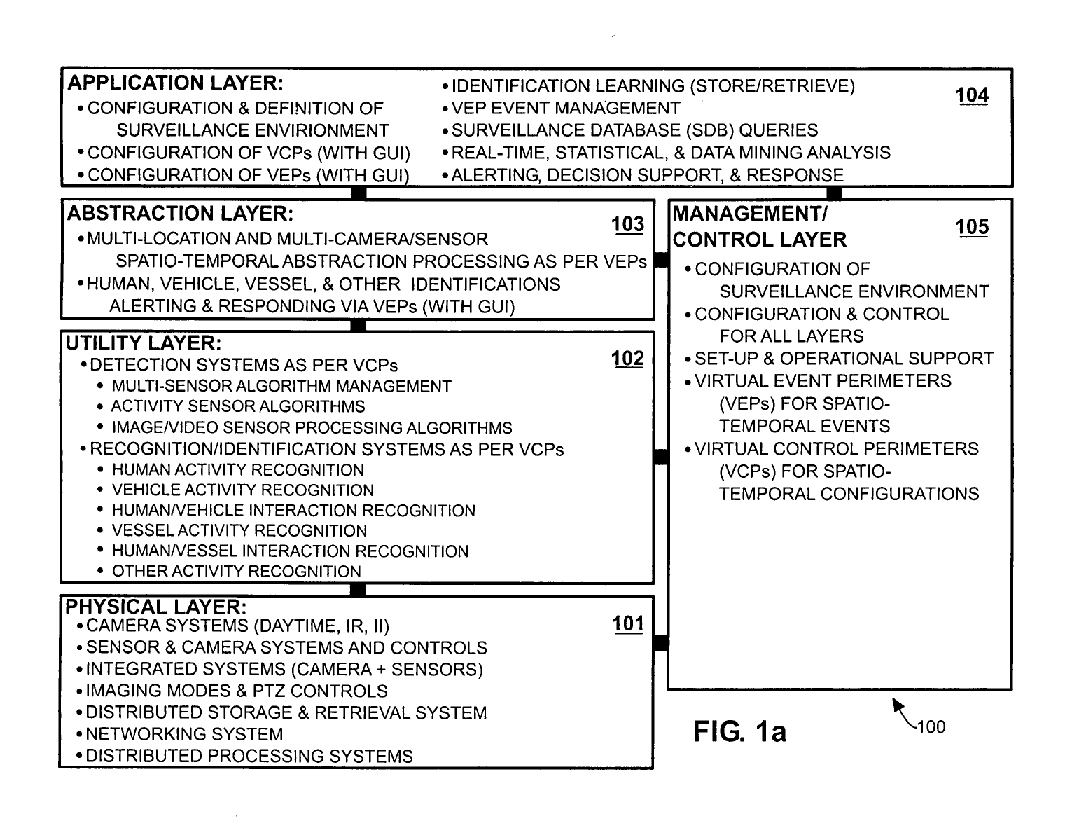

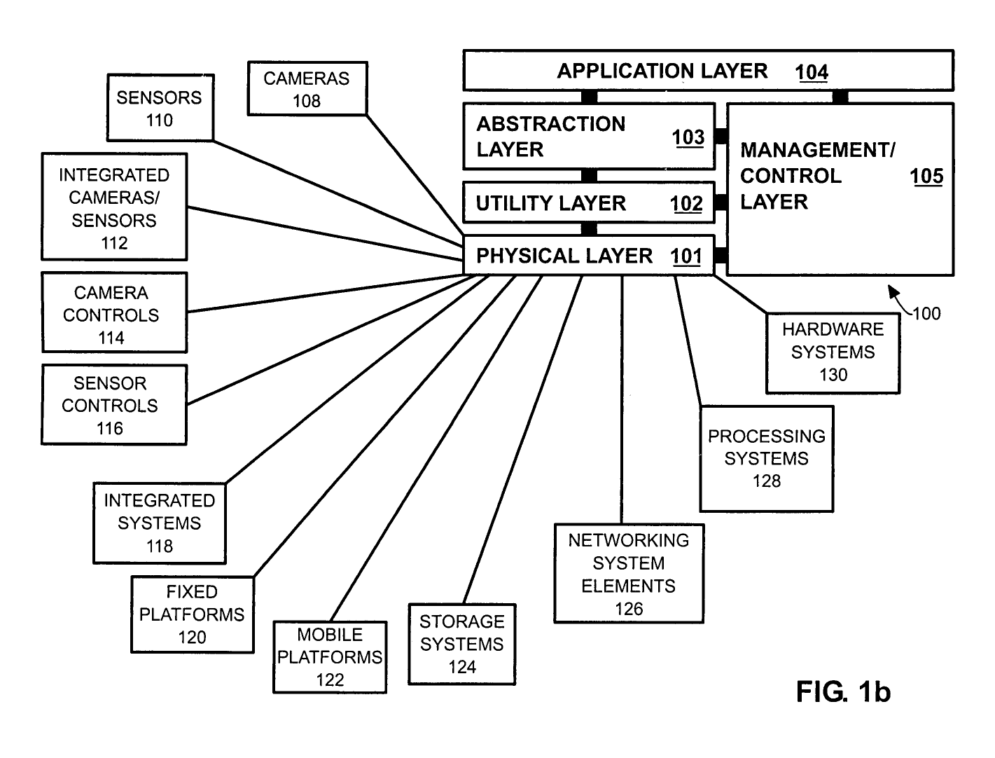

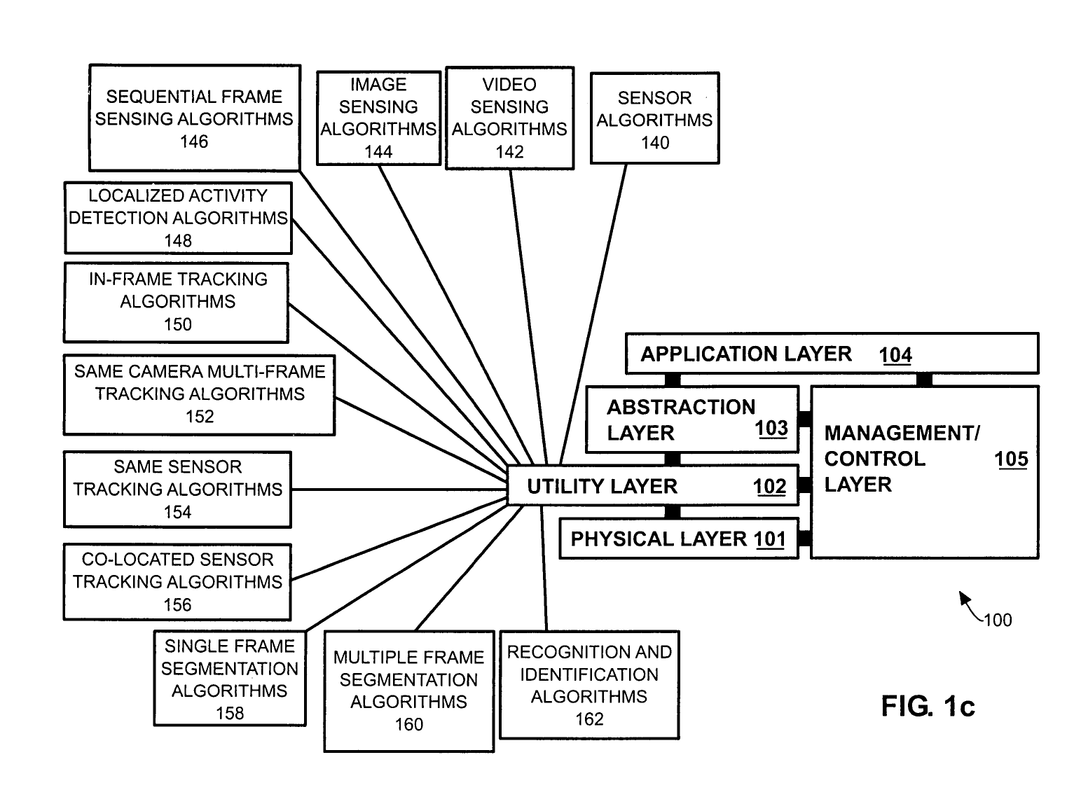

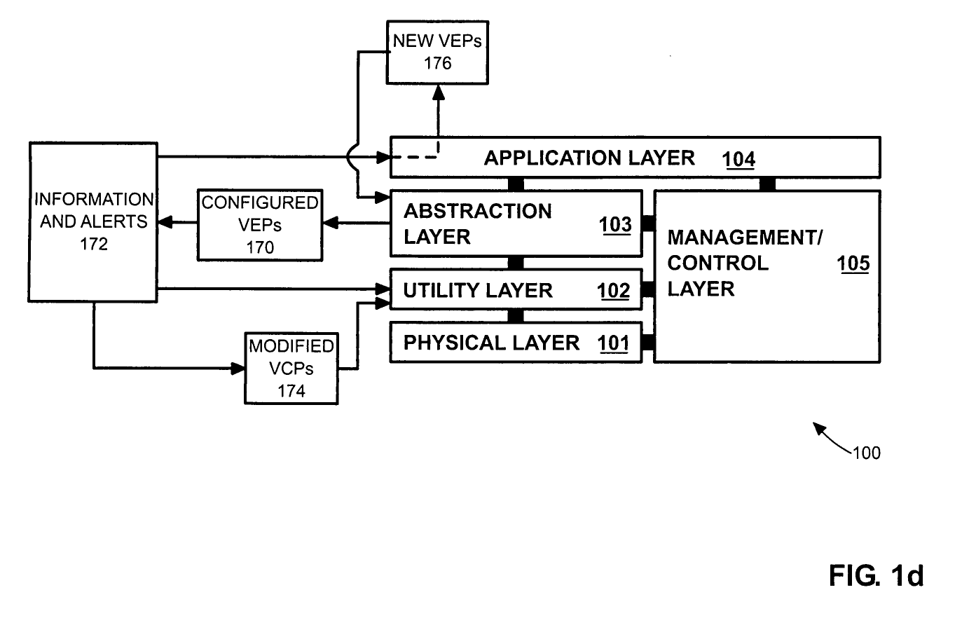

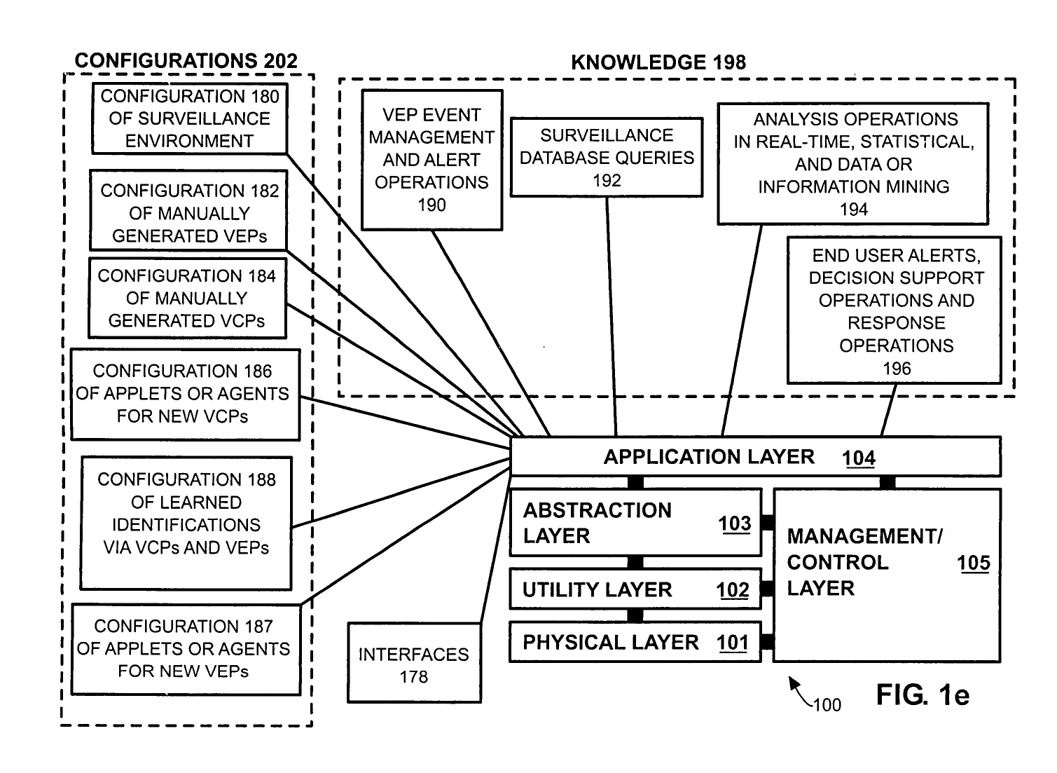

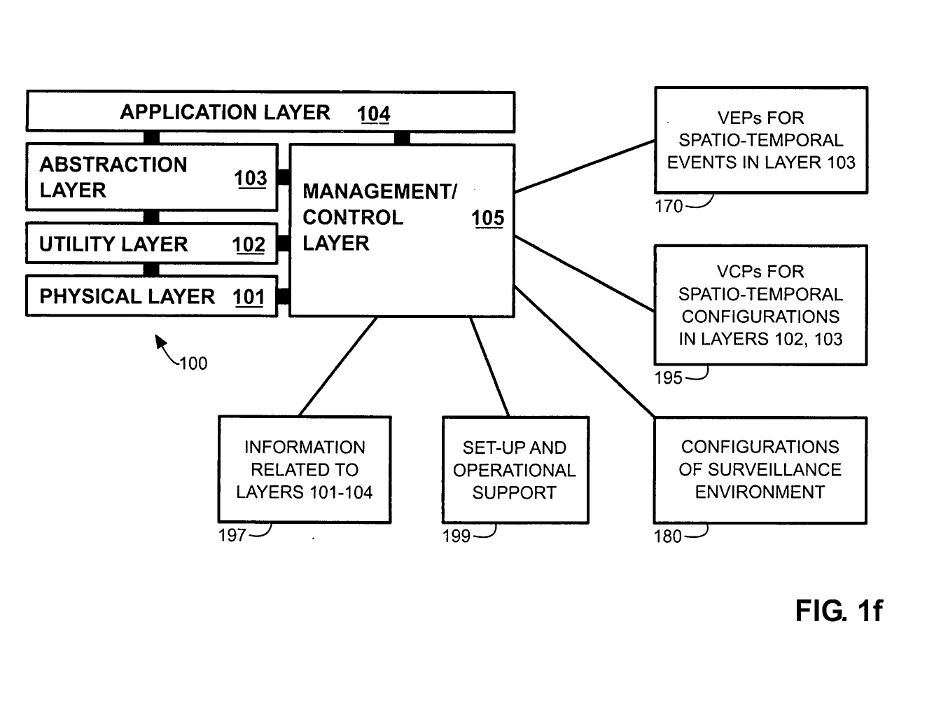

FIGS. 1 through 28 show the various apparatus, methods and systematic aspects of the invention, which together with the various embodiments of the invention presented herein, help to present the principles of the invention. These descriptions should not in any way be construed as to limit the scope of the invention. Those skilled in the art understand that the principles of this invention may be implemented in any suitably designed automated and adaptive surveillance system with the same fundamental constructions and processes of the apparatus, method and system of this invention.

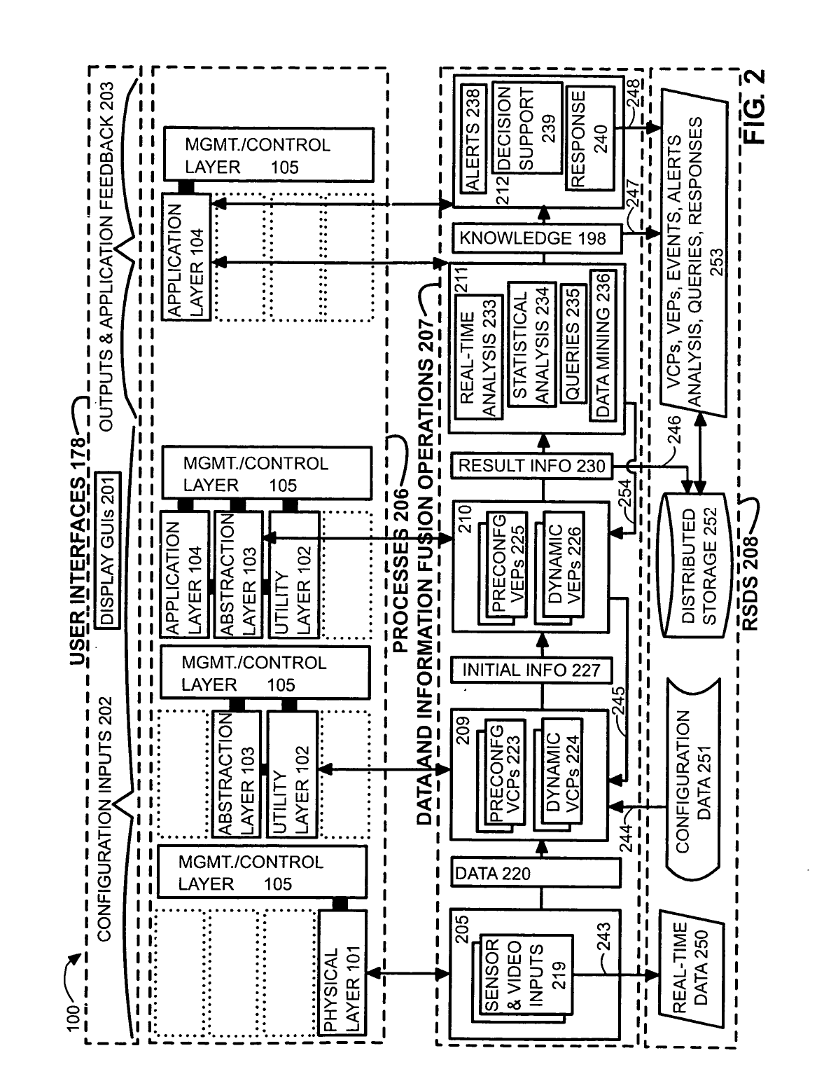

FIGS. 1a-1f illustrate the principal processes and components of the apparatus, system and method of the surveillance system 100 of the invention, while FIG. 2 illustrates the methods of the overall system 100 including the following: user interface operations; process operations; data and information flow and fusion operations; and the operation of the surveillance database, as will be described in more detail below with respect to FIG. 2. FIGS. 1a-1f and FIG. 2 illustrate the basic embodiment of the invention, and are fully described in the following paragraphs.

FIG. 1a illustrates a system design for the method of the invention which is comprised of five major subsystem or processing sub-elements: a physical layer 101; a utility layer 102; an abstraction layer 103; an application layer 104; and a management/control layer 105. As also illustrated in FIG. 1b, physical layer 101 comprises all of the hardware elements associated with the end-to-end system for an automated surveillance solution. It includes cameras 108, sensors 110, integrated cameras with sensors 112; camera controls 114, such as imaging modes and PTZ controls; sensor controls 116; integrated systems 118, which are not necessarily co-located but work cooperatively, such as remote sensors in the field of view of cameras 108; fixed platforms 120, mobile platforms 122; storage systems 124 for the RSDS, which may be in a local or distributed form; networking system elements 126, which are wireless or wired; processing systems 128 that are local or distributed, and any and all hardware systems and other components 130 for supporting all the operations of the processing sub-elements in utility layer 102, abstraction layer 103, application layer 104, and management/control layer 105.

Further, FIGS. 1a and 1c illustrate utility layer 102 for performing utility operations on and controlling the gathering of data by surveillance devices, such as cameras 108 and sensors 110. Utility layer 102 comprises all of the prior art utility algorithms and new and evolving processing algorithms for automated detection using multiple sensors or cameras. It uses various sensor algorithms 140, video sensing algorithms 142, image sensing algorithms 144, sequential frame sensing algorithms 146, localized activity detection algorithms 148 for surveillance devices such as single or multiple sensors 110 and/or single or multiple cameras 108 and/or for single or multiple integrated camera/sensor systems 112. It also incorporates in-frame tracking algorithms 150, same camera multi-frame tracking algorithms 152, same sensor tracking algorithms 154, co-located sensor tracking algorithms 156, single frame segmentation algorithms 158, multiple frame segmentation algorithms 160, and any other highly localized algorithms related to readily available localized algorithms that can be deemed to become part of the “utility” functions of utility layer 102 and are considered in the art to be readily deployable and available algorithms. The latter can be incorporated in distributed processing hardware or firmware that performs these operations and generates information from the real-time data obtained from the real-time generating data hardware of surveillance devices, such as sensors 110 and cameras 108. Utility layer 102 also contains recognition and identification algorithms 162, which have also been configured by VCPs to detect activity related to humans, vehicles, vessels, animals, objects, actions, inter-object interactions, human/vehicle interactions, human/vessel interactions, vehicle/vehicle interactions, any other interactions thereof, and any other activity or basic events within frames, sequential frames, same-sensor or group-of-sensors basic events, multi-class of sensor events. These can be identified and linked to the surveillance database data generated by physical layer 101 as information generated by utility layer 102 in relation to the basic events detected and recognized by the utility layer processes of utility layer 102.

Further to the above, FIGS. 1a and 1d illustrate abstraction layer 103, which comprises all the VCP configured large-scale spatio-temporal processing related to multiple location and multiple camera and sensor processing of the information generated by utility layer 102, and which is defined by configured VEPs 170 that, when activated by that information, results in alerts and information 172 from specific identifications programmed in the VEP configurations of configured VEPs 170. Further systems and method information in relation to the data and information flow is left for the description of FIG. 2 below. The resulting alerts 172 from abstraction layer 103 are presented to the application layer 104 and are also used to modify VCPs 174 in utility layer 102 to automatically refine ongoing real-time operations. Similarly, information 172 resulting from abstraction layer 103 can be used during queries by application layer 104 to generate new VEPs 176, which in turn produce new information related to new spatio-temporal relations among data and information contained in a linked surveillance database that is part of storage system 124 illustrated in FIG. 1b.

In addition, FIGS. 1a and 1e illustrate application layer 104, which comprises all the processing related to interfaces 178 with the end-user in all aspects related to configuration and definition 180 of the surveillance environment of surveillance system 100. It includes configuration 182 of manually generated VEPs; configuration 184 of manually generated VCPs; configuration 186 of applets or agents in VEPs to generate new VCPs for automatic and adaptive surveillance operations in abstraction layer 103 and utility layer 102; configuration 187 of applets/agents in VEPs to generate new VEPs for automatic and adaptive surveillance operations in abstraction layer 103; configuration 188 of learned identifications via VCPs and VEPs; VEP event management and alert operations 190; performance and management of surveillance database queries 192; performance and management of analysis operations in real-time, statistical, and data or information mining 194; and performance and management of end-user alerts, decision support operations, and response operations 196. Application layer 104 provides all end-user interface operations for the automatic and adaptive surveillance system of this invention. While a relational surveillance database can contain all the information of the system, only the operations in application layer 104 support the views of the end-user. As further illustrated in FIG. 2, application layer 104 receives configurations 202 from the end-user and generates knowledge 198 as part of the data and information fusion that progresses through the system 100 of this invention.

Furthermore, as illustrated in FIGS. 1a and 1f, management/control layer 105 is the only set of processes that interface directly with all other layers 101-104 and is used to pass all the information 197 related to configurations of every layer 101-104. Management/control layer also performs functions for set-up and operational support 199; configurations 180 of the surveillance environment, such as defining location areas scope, activities, relationships, and the like, which define VCPs and VEPs; and VCPs 195 for spatio-temporal configurations in 102 and 103; and VEPs 170 for spatio-temporal events in 103.

FIG. 2 further illustrates the method and system of the invention. An end-user interacts with system 100 via user interfaces 178, which are part of application layer 104 and are displayed by any suitable device of physical layer 101, such as a computer monitor (shown as hardware systems 130 in FIG. 1b). User interfaces 178 may include display GUIs 201, which are designed using well known prior art. Suitably designed GUIs may be included for the various applications of application layer 104, starting with configuration inputs 202, as described previously. In addition, via user interfaces 178, we obtain all the outputs and application feedback 203 resulting from the end-user applications, which are also displayed using suitable GUIs 201.

Further illustrated in FIG. 2, following the framework of the processes 206 of the system and method as in layers 101, 102, 103, 104, and 105 of FIGS. 1a-1f, they are used at different stages of the data and information fusion operations 207 in the information flow. We start with a first step 205 of the data and information fusion operations 207, whereby real-time sensor and video/image inputs 219 result in gathered surveillance information data 220 from the physical layer 101, as enabled by management/control layer 105. Further, gathered data 220 can also be stored locally or in distributed form, as illustrated by arrow 243, in a real-time data section 250 of a relational distributed sensor and video surveillance database (RSDS) 208. Other ancillary and linked data is included in gathered data 220, and is related to the surveillance data structures of the associated real-time gathered surveillance information, and is also stored in RSDS 208, even when there is only partial real-time data.

Data 220 is also passed to a second data/information fusion step 209 to be processed by utility layer 102 and abstraction layer 103. In this step, pre-configured VCPs 223 obtained from configuration data 251 of RSDS 208 and dynamically created VCPs 224, obtained in a manner to be described below, are used to obtain and analyze data 220 via the various algorithms of utility layer 102 and abstraction layer 103. Initial information 227 generated by the algorithms of utility layer 102 and abstraction layer 103 are passed to a third data fusion step 210, which is another cycle through utility layer 102 and abstraction layer 103 for the purpose of activating pre-configured VEPs 225 and dynamically generated VEPs 226. This might, in turn, generate more dynamic VCPs 224 as shown via arrow 245 and communicated via management/control layer 105 as part of the functionality of management/control layer 105. The resulting information 230 can be analyzed in real-time by application layer 104 or it is stored, as illustrated by arrow 246, as part of the stored generated VEPs and VCPs 253 in distributed storage 252 of the RSDS 208.

Furthermore in FIG. 2, the resulting information 230, after the recursive generation of dynamic VCPs 224 and VEPs 226, or through the use of any existing and still active pre-configured VCPs 223 and VEPs 225 is presented to the application layer 104. This is supported by the management/control layer 105 in a fourth step 211 of the flow to perform real-time analysis 233, statistical analysis 234, queries 235, and data mining 236. These operations can also create new dynamic VEPs 226, as illustrated by arrow 254, via applets or agents to modify how system 100 becomes sensitive to new spatio-temporal trends that are identified by application layer 104 operations. These sets of operations in application layer 104 result in knowledge 198, which is also stored in RSDS 208 as part of distributed storage 252, 253, as illustrated by arrow 247. In a fifth step, 212, the resulting knowledge 198 is used with GUIs 201 of application layer 104 as part of the outputs and application feedback 203 to provide alerts 238, decision support 239, and automatic or manual response generation 240. These are also stored in RSDS 208 distributed storage 252, as illustrated by arrow 248.

Configuration of the Surveillance Environment: The first step in preparing the surveillance environment for automated and adaptive surveillance is to define the scope of the global space and coverage target, hereinafter the Surveillance Universe (SU). Once the SU is defined with the required physical layer 101 assets (e.g., surveillance devices and other equipment) in place, then pre-configured operational parameters are identified for the complete definition of initial static/preconfigured VCPs 223 (in FIG. 2), initial static/preconfigured VEPs 225 in FIG. 2, initial real-time analysis 233, and applications in the application layer 104. Surveillance Universe (SU) examples can be deployed to cover various locations on land, on water, in air space, inside buildings, and other environments where sensors and/or video can be deployed, such as tunnels, underwater swimmer detection systems, passenger aircraft, trains, ships, and the like. In several of the preferred embodiments, the SU is massively and pervasively populated with sensors and camera systems to provide the maximum usable coverage and configurations possible as considered by the fixed systems as those that can be used with fixed platforms and various VCPs and VEPs are defined and can be dynamically generated to provide the fully automatic and adaptive surveillance capability of the invention.

In other preferred embodiments of the invention, the SU has to be configured for mobile platforms with sensors and/or video/image camera systems such as those of individual, multiple, or swarms of UAVs and Organic Air Vehicles (OAVs) which could work together with or in the absence of other fixed sensors and cameras. They could also work with sensors mounted on mobile land, air, or waterborne vehicles but their Global Positioning System (GPS) or relative locations are all known to the system and correspondingly, the enabling configurations will operate accordingly. Moreover, multiple mobile platforms work cooperatively by virtue of the defined and dynamically generated VCP and VEP configurations, which use data structures and applets or agents to automatically respond to events and adaptively change the profiles of the required responses according to the evolving dynamics of the SU.

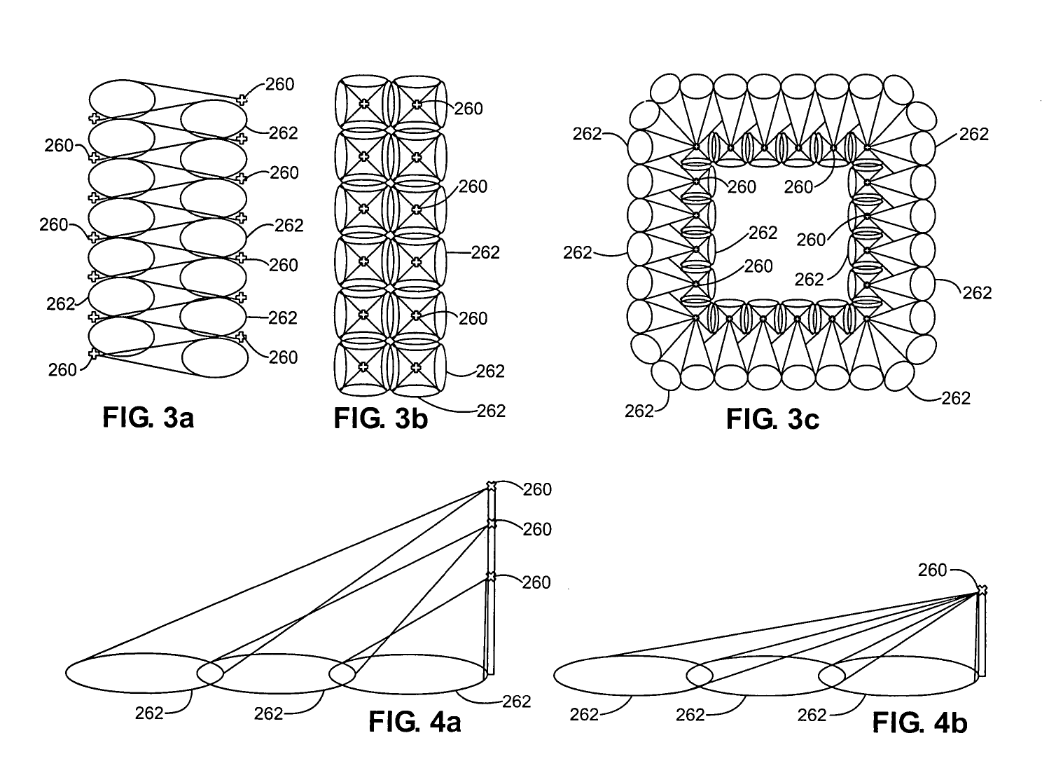

Examples of coverage configurations are shown in FIGS. 3a-3c and 4a-4b. FIGS. 3a-3c illustrate three examples of camera system and sensor system coverage over a physical location. Cameras, sensors, and/or integrated camera/sensor systems are illustrated as surveillance devices 260. Each surveillance device 260 has a FOC or FOV 262 associated with it, designating the coverage of that particular surveillance device 260. By properly positioning the FOC/FOV 262 of each surveillance device 260, an area of a surveillance environment may be covered. The surveillance device deployment configurations illustrated in FIGS. 3a-3c may be used as the building blocks for massively and pervasively deployed camera/sensor systems in a variety of environments; example, perimeter protection or surveillance target coverage. Similarly, FIGS. 4a-4b demonstrate examples of vertical camera/sensor system deployment for increased coverage in a VCP, employing similar surveillance devices 260 described above with respect to FIGS. 3a-3c having FOC/FOVs 262.

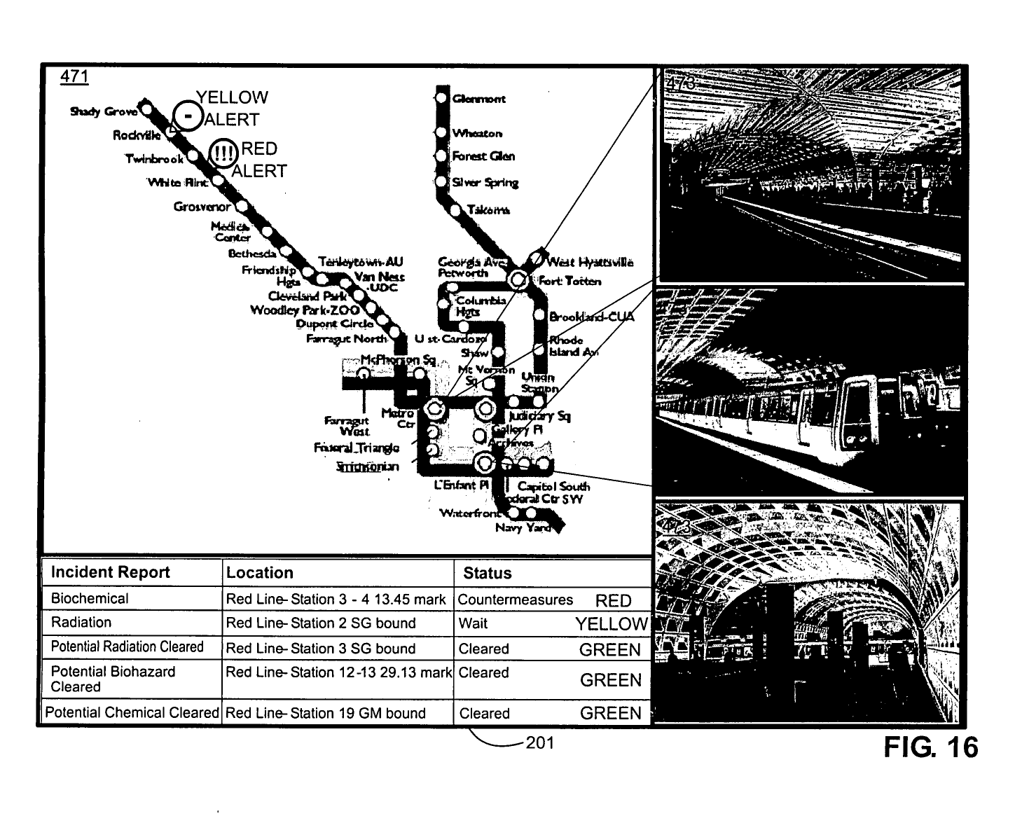

Because of the different SUs encountered in real-life surveillance situations, we may subdivide the SU into multiple sub-SUs to be managed separately. Additionally, an SU can encompass completely different environments such as land, air, water, underwater, and buildings. Examples of fixed land coverage modes for the physical deployment of cameras and sensors in fixed locations are exemplified in FIGS. 3, 4, and also in FIGS. 16, 22, and 28, which will be discussed in the examples below. Other examples may have simple subdivisions such as in trains and tunnels applications where the tunnels, stations, station platforms, station entrances/exits, station elevators, station escalators, trains, and elevated tracks are identified and a suite of algorithms performed in the fundamental processes are different according to the subdivisions in which they are used. For example, the utility layer 102 algorithms for activity detection and identification 148 are different for a platform versus the ones used for a tunnel. In another example, the algorithms for train tracks provide segmentation of the frame so that specific algorithms are used for activity detection and identification on the tracks versus any other algorithm applied for the segments of the frame from the same camera that processes the platform as being different from the tracks. Thus, with the aid of automated activity identification, we can now provide complete coverage for all installations since they no longer depend on human-operator-based detection and identification. Therefore, the richness of coverage with camera systems and sensor systems enables a completely new level of coverage unequaled by conventional detection video surveillance systems.

SUs with pervasively and massively deployed cameras and sensors may not require PTZ, FOV, and other sensing field manipulations for the cameras and sensors in most cases. However, when such manipulations occur, they occur in response to activated VCPs which could in turn be generated by VEPs. These manipulations are a direct result of automatic and adaptive operations that occur as part of the surveillance system operation, as was described above with respect to FIGS. 1a-f and 2. Consequently, and as a result of the flexibility and functionality of the method and system in this invention, complete coverage can also be provided for camera and sensor systems that are located on movable platforms such as those mounted on UAVs or OAVs. This invention also has preferred embodiments for operation of surveillance systems using integrated and coordinated sensors and/or camera systems which operate on UAVs and on fixed or movable air and ground platform locations. Sensors and/or cameras can be standed-off from each other and operate cooperatively in environments where fixed and mobile sensors and cameras are deployed and total mutual awareness is to be integrated as part of the end-to-end system of the invention.

Virtual Configuration Perimeter (also known as Virtual Configuration Parameters) (VCP): The VCP is the vehicle of choice to configure all the spatio-temporal parameters associated with physical layer 101, utility layer 102, abstraction layer 103, and application layer 104. For example, VCPs incorporate the PTZ settings and FOV settings in physical layer 101, the type of activity detection algorithms in utility layer 102, the logical operation algorithms in abstraction layer 103, and the real-time analysis and trend analysis algorithms in application layer 104. VCPs are generic and independent of the evolution of camera systems, sensor systems, image processing algorithms, processing speeds, databases, storage capabilities, and other technological factors. VCPs incorporate all the configuration parameters for automated and adaptive digital video surveillance in government, military, and commercial applications. One of the biggest attributes of the VCP configurations is that it can be extended to allow multiple, apparently unrelated, camera/sensor systems to work cooperatively on the same event as it could happen with neighboring or adjacent camera systems. Multiple VCPs can be set up for the same camera systems, sensor systems, all physical layer systems, and/or SUs. The VCPs are specific to the configuration of the following parameters:

Location: encompasses the locations of the cameras/sensors and the coverage location areas according to any coordinate system. The GUI development for the set up of VCPs is driven by the physical location and the available configuration settings for the physical layer 101 equipment at these locations and the intended coverage areas. This location relation extends to even remotely-located systems whose FOVs are coincident or which could be coincident as a result of a position change in a mobile platform. Thusly, new, dynamically generated VCPs may be created automatically for redefining the operations in the utility layers 102 operating on the real-time data from the supporting physical layer 101 systems identified in these VCPs. Sensors and cameras may be static or dynamic, and can be located on movable or moving platforms. Accordingly, there is enough richness of parameters in the data structure of the VCP description to incorporate any and all moving or movable parameters that affect the full definition of profiles and configurations related to VCPs to characterize all location information related to the motion of sensors and/or cameras. This motion-deterministic information includes but is not limited to direction of travel, speed of travel, track, duration of travel, FOVs, FOCs, and the like.

Sensors and Sensor Systems: include specific sensors and sensor modes (e.g., different thresholds such as radar target size, different biopathogen size thresholds for biohazard or chemical aerosol cloud sensor) according to temporal parameters (e.g., time of day, day of the week, holiday, etc.), weather conditions (e.g., rain, fog, snow, wind, etc.), and according to location parameters that also influence the sensor settings (e.g., water, land, distance to target, etc.).

Cameras and Camera Systems: refer to specific video camera configurations, PTZ settings for each camera or group of cameras, imaging modes for cameras and camera systems (e.g., wide field or narrow field, IR—Infrared—settings, II—Image Intensification—settings), resolution settings (e.g., prosecution quality, high compression quality), turn-off/turn-on settings (e.g., time of day, day of the week, holiday, weather related, etc.), interaction with sensor systems (e.g., turn on camera systems on specific sensor triggers or detection, or turn off on lack of sensor triggers in a time period, etc.).

Networking Systems: the networking system parameters are also taken care of by the VCPs and are managed at the management/control layer 105. The network system configurations can be static or dynamic according to system considerations related to digital video surveillance coverage in one or more SUs, support for wired and wireless networks, and other network considerations related to command and control centers which could be local or remote (e.g., system can be run remotely and response is local). Additional considerations relate to availability, redundancy, and reliability.

Storage and Retrieval: the storage and retrieval system parameters are also taken into account by the VCPs. The storage and retrieval parameters also have spatio-temporal considerations related to locations of camera systems whose video streams need not be recorded even if they are operative, or specifically located camera systems whose stored video streams can be erased after a certain period of time or archived after a certain period of time. Similarly, other temporal considerations may determine the periodicity of archival of all databases of the system, and the amount of data that is located in a distributed form versus a centralized form.

Detection Systems: The detection systems in utility layer 102 contain parameters related to sensor fusion settings (e.g., based on neural fusion of sensor detection triggers such as more than one kind of sensor trigger in co-located sensors, sensors having the same FOC, network of multi-sensors, etc.); image processing activity detection settings (e.g., specific type of algorithm activation based on land-based or water-based activity detection, or based on specific type of activity detection/recognition such as vehicle, human, or vessel); and interaction between sensor fusion settings and types of frame-to-frame image processing settings to be used (e.g., specific types of algorithms to be used after specific type of sensor trigger such as different focal length IR for a long distance radar setting trigger).

Recognition/Identification Systems: The recognition/identification systems 162 in utility layer 102 contain parameters related to the types of recognition settings to be used and the types of activity identifications to be performed (i.e., predetermined characteristics of interest to be recognized) for different locations or different times. These configurations determine which types of recognition and identification algorithms 162 need to be run (e.g., if small targets are detected then animal or human activity identification algorithm is performed instead of vehicle activity identification; or, if small flying objects with IR trigger are detected, bird activity identification algorithm is performed; or, if a small floating object with IR trigger is detected, human activity in water algorithm is performed. Still, other algorithms may be executed for human group activity, vehicle type identification, license plate recognition, face recognition, gait recognition, etc.).

Abstraction Systems: The VCP parameter settings for the abstraction layer 103 relate directly to the types of activities targeted by the system. In the case of the activity detection applications, those settings specifically target human activity, vehicle activity, vessel activity, human/vehicle interaction activity, and human/vessel interaction activity, which may fall under the category of “critical event.” Other activities such as animal activity identification, wind moving object activity, and so on, may fall under the category of “non-critical” events. But even potential “critical events” that are identified at abstraction layer 103 can be configured for “non-alert” and response according to spatio-temporal parameters determined by the environment (e.g., sentry vehicle on the access road in specific time window, human walking parallel to fence perimeter and outside area of imminent danger, etc.) The VCPs are used to setup the configurations that trigger the “critical events” that are also “alerting events” and correspondingly require a response or no response decision by triggering a VEP as discussed in the next definition.

Application Layer: The VCP parameter settings specify the type of real-time analysis, statistical analysis, and trend analysis functions that are used to process the information obtained from the abstraction layers 103 from the various distributed subsystems.

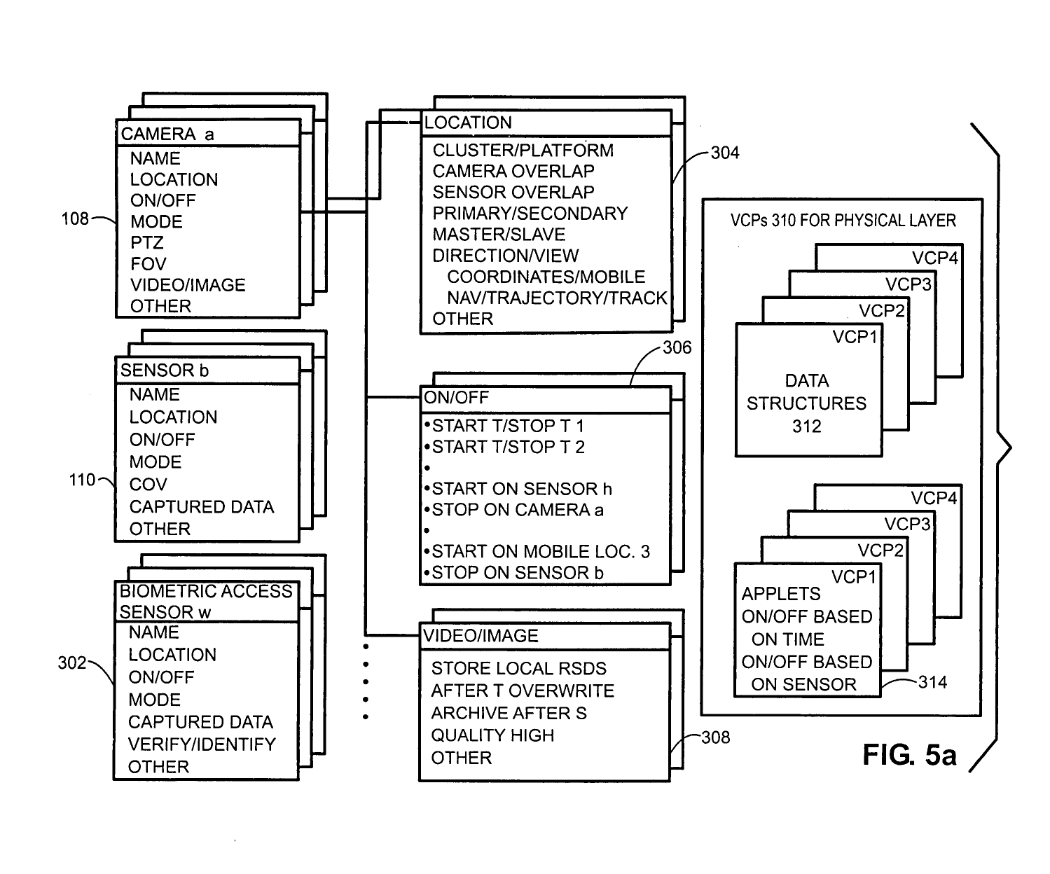

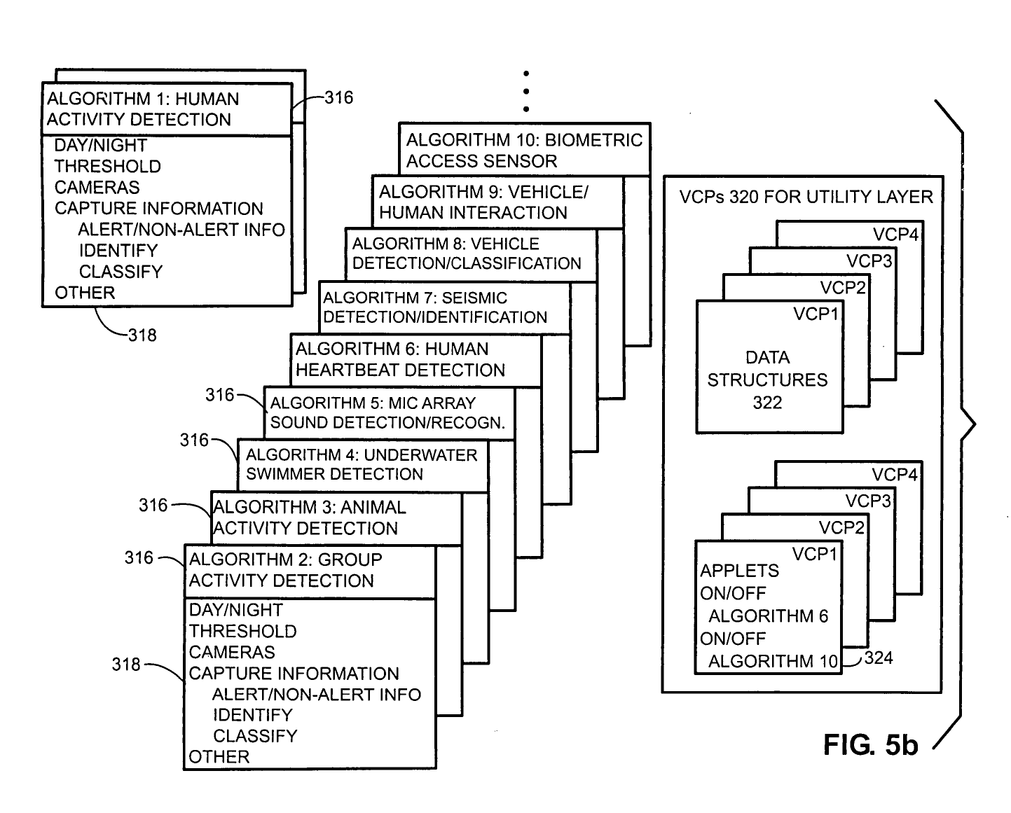

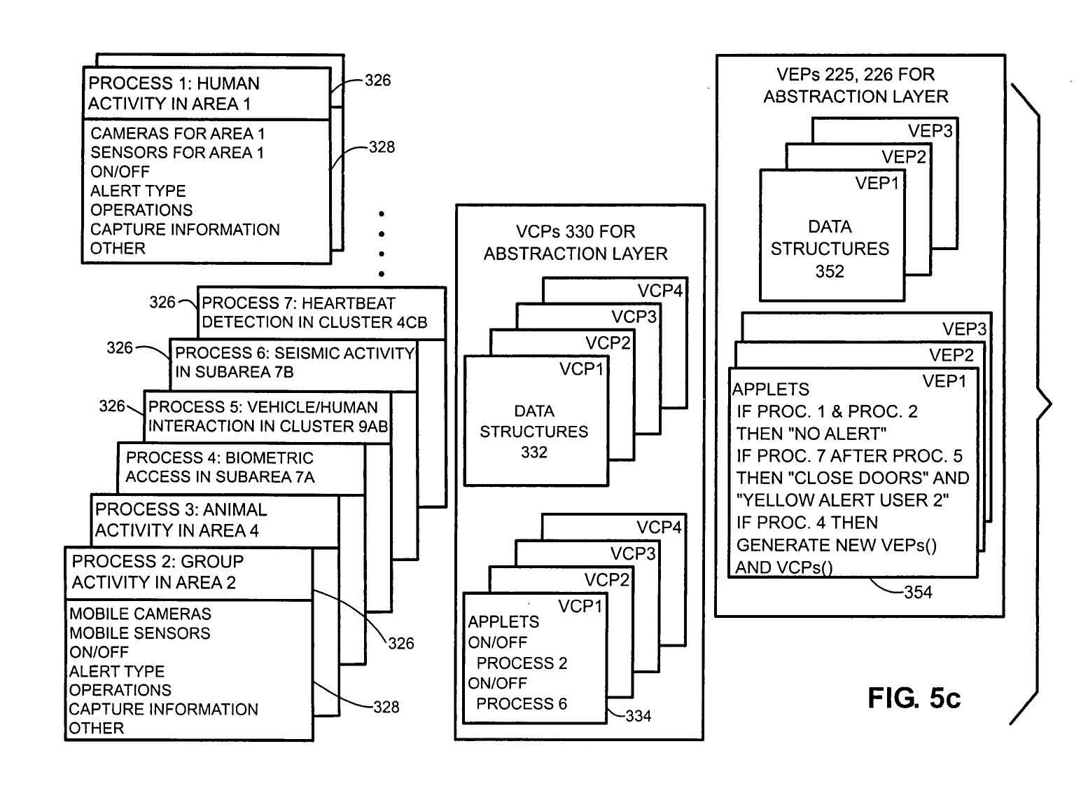

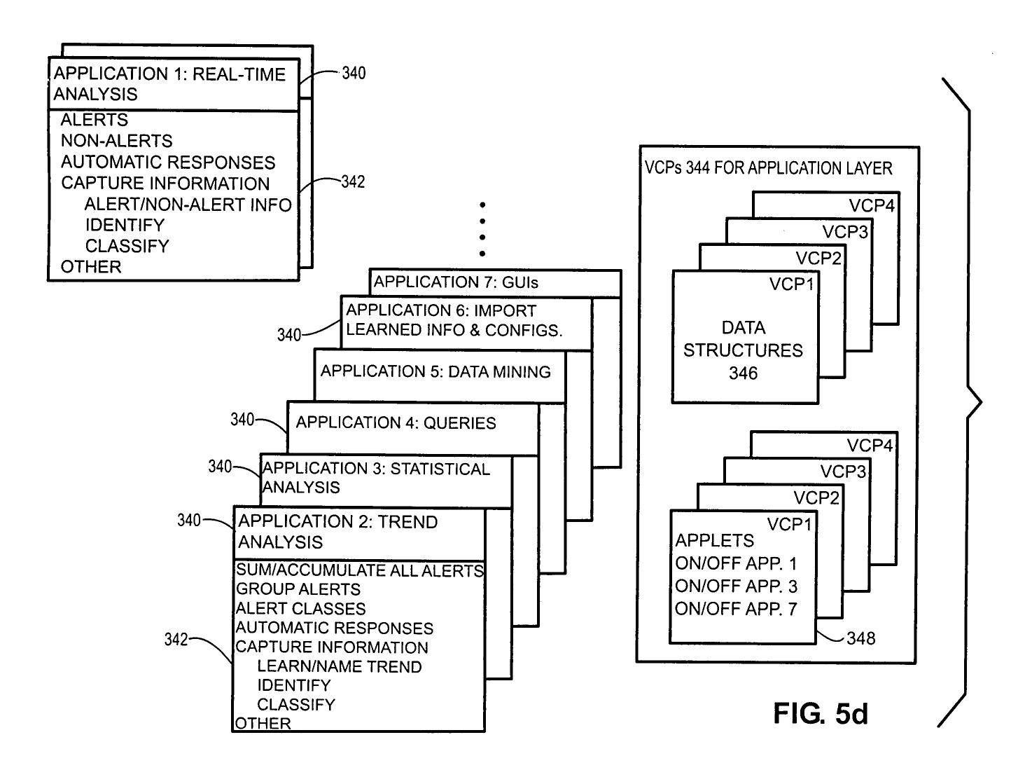

FIGS. 5a-5d describe sample versions of VCPs for each one of the layers: physical, utility, abstraction, and application. FIG. 5a shows how the data structures for the physical layer 101 elements such as cameras 108, sensors 110, and biometric access sensors 302 are configured according to specific parameter data within the data structure such as location information 304, on/off setting data 306, and video/image capture data 308, as examples. Correspondingly, physical layer VCPs 310 are comprised of these data structure definitions 312 and executable applets and/or agents 314, which can be conditionally exercised according to specific data parameters and conditions from the associated data structures.

FIG. 5b shows how the data structures for utility layer 102 are developed to classify and define all algorithms 316 to be used with any and all utility layers 102 that are applied to subsystems to process physical layer 101 data. Inside each data structure there are identifiers 318 for the target data to be processed such as that coming from a specific camera or sensor. Correspondingly, utility layer VCPs 320 are comprised of these data structure definitions 322 and executable applets and/or agents 324 which trigger specific algorithms with specific VCP utility data structure parameters from the data structure parameters.

FIG. 5c shows how the data structures for abstraction layer 103 are developed to classify and define all processes 326 to be used with any and all abstraction layers 103 that are applied to subsystems to process the utility layer 102 information. Inside each data structure there are identifiers 328 for the target information to be processed such as that coming from a specific area, sub-area, or cluster of camera or sensor locations. Correspondingly, abstraction layer VCPs 330 are comprised of these data structure definitions 332 and executable applets or agents 334 which trigger specific processes with specific VCP abstraction parameters from the associated data structure parameters. Also illustrated in FIG. 5c are the VEP data structures and applets or agents whose operations are described in more detail below.

FIG. 5d shows how the data structures for application layer 104 are developed to classify and define all applications 340, to be used with any and all application layers 104 that are applied to subsystems to process the abstraction layer information. Inside each data structure there are identifiers 342 for the target information to be processed by the applications such as that related to specific types of alerts, responses, groups of alerts, groups of responses, and the like. Correspondingly, application layer VCPs 344 are comprised of these data structure definitions 346 and executable applets or agents 348 which trigger specific applications with specific VCP application parameters from the associated data structure parameters.

Virtual Event Perimeter (VEP): VEPs are set up using data structures and applets or agents to perform the global spatio-temporal abstractions performed in the abstraction layer 103 in FIGS. 1a, 1d, and 2. As illustrated in FIG. 2, VEPs 225, 226 are set up to perform operations on VCPs 223, 224. VEPs are of two kinds: preconfigured/static VEPs 225 to get the system started, and dynamically generated VEPs 226, which are generated by preconfigured VEPs according to well defined rules set forth by the surveillance environment and the end-user configuration inputs 202 of FIG. 2 relating to the surveillance environment set-up. VEPs 225, 226 perform logical, arithmetic, mathematical, statistical, data mining, filtering, and neural network operations on the results of VCPs 223, 224 coming from multiple utility layers 102. VEPs 225, 226 are the vehicles by which a given event (that is triggered at abstraction layer 103 through the result of operations on VCPs 223, 224 to extract large scale spatio-temporal relationships) is readied for analysis at the application layer 104 and/or for retrieval of the event in the RSDS 208. VEPs 226 can also be generated as a result of application layer operations as in the feedback operation illustrated by arrow 254 in FIG. 2. Thus, VEPs 226 are recursive via the resulting information generation operation 230 of FIG. 2, and the knowledge generating operation 198 of FIG. 2. All automatic and automated surveillance events trigger VEPs 225, 226.

VEPs 225, 226 can be of different kinds. For activity detection applications, VEPs 225, 226 can be used for “critical events” that require alerting humans and response actions by the proper personnel. VEPs 225, 226 can also trigger non-alerting responses but are stored in RSDS 208 so that they can be used by the learning system automatically or analyzed by the application layer 104 or an operator/end-user off-line. All events resulting in VEPs 226 are stored in RSDS 208 (since most of the target video and sensor information is recorded in the database 208, the VEPs and their associated information are already in the database and since the database is a relational database, then only the new database link and reference entries associated with the VEPs need to be stored as new information in the database).

FIG. 5c shows the VEP structures 225, 226 associated with abstraction layer 103 where all the spatio-temporal processing takes place after all the information 227 from the contributing utility layers 102 is processed by operations in the VEPs 225, 226. The abstraction layer VEPs 225, 226 use data structures 352 as exemplified in processes 326 together with operations defined by applets and/or agents 354 in each VEP 225, 226 to obtain specific event alerting information to be passed to the end-user or other applications via application layer 104. VEP operations can be as simple as passing some utility information results creating an alert based on the output information from any utility algorithm, or as complex as a set of logical operations performed on the outcome of multiple utility layer algorithms being performed on camera and/or sensor data coming from the same camera, or multiple clustered cameras processed by the same utility layer and abstraction layer in a subsystem. It is also important to point out that only through the combination of static and dynamic VCPs and VEPs, can the method and system of this invention automatically and adaptively respond to surveillance alerts resulting from mobile platforms such as those found in flying platforms or mobile robots by the generation of new VCPs 224 (in any or all layers) and VEPs 226 in the abstraction layer as exemplified by applets/agents 354.

The use of VEPs becomes significant when considering that the “critical alerting events” need to be presented to the human operator with the proper application layer application and the proper GUI. This application presents in some suitable form, all of the RSDS information relevant to the event. That information can be presented with a simplified GUI that permits a complete spatio-temporal presentation of the critical event because of the richness of the information available from the database in the resulting VEP.

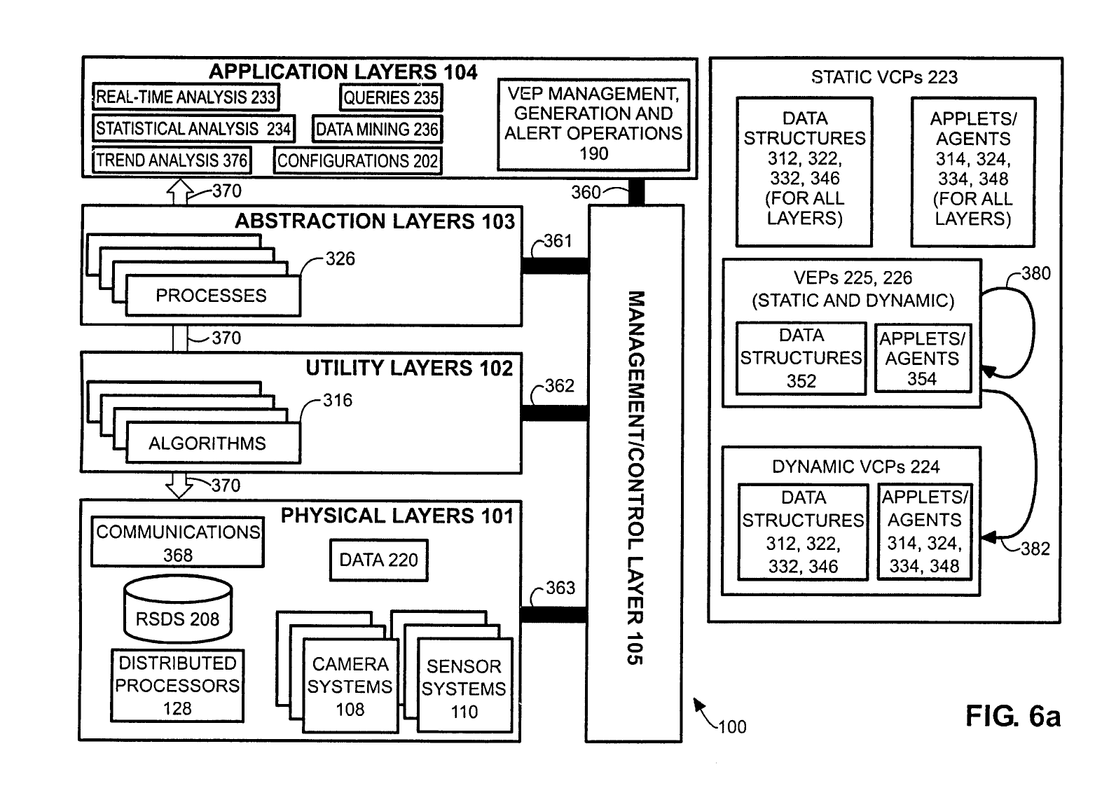

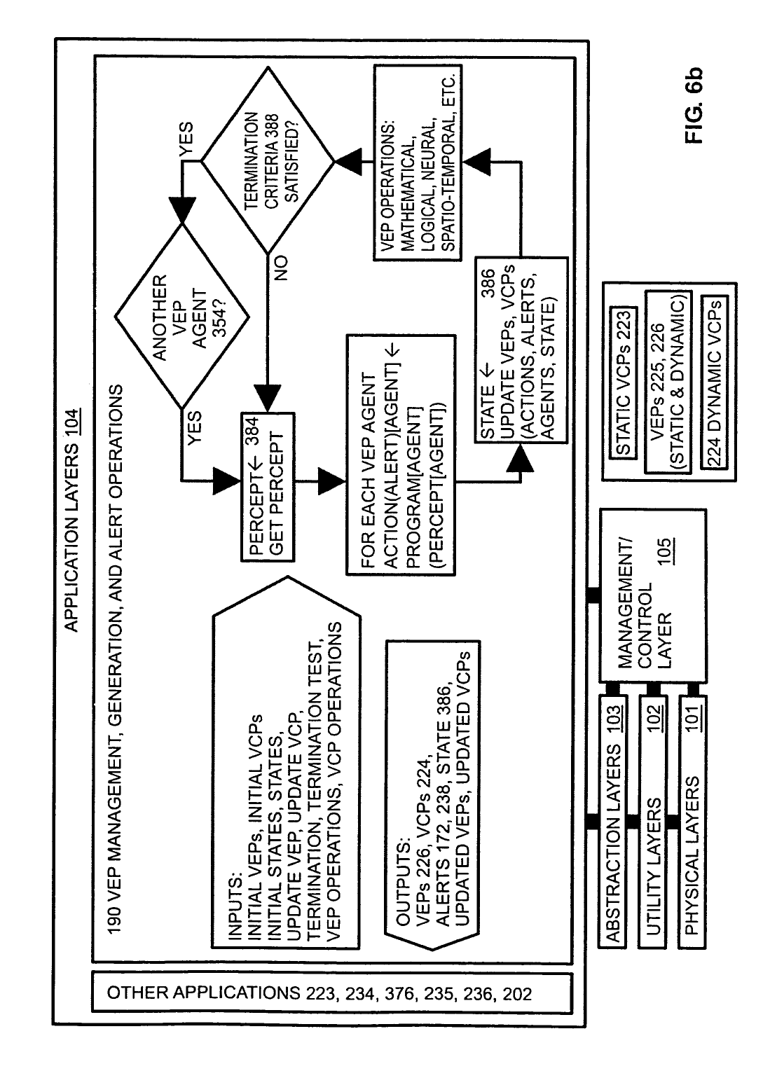

VCP and VEP Operations: The VCP and VEP configurations are used to effect the method of providing automatic and adaptive control of the surveillance system of the invention. As shown in FIG. 6a, preconfigured static VCPs 223 are used to configure all operations of the processing layers of every subsystem. These static VCPs originate with the configurations 202 applications of application layers 104 and are passed to each layer via the management\control layer 105 using internal communications 360, 361, 362, 363 of each subsystem. Static VCPs 223 include data structures 346 and applets or agents 348, which are used to provide parameters to the physical layers 101 for initial configuration of all physical assets of the system 100. These physical assets include the distributed RSDS 208, communications systems 368 of every subsystem, and the subsystems with distributed processing systems 128. Furthermore, the static VCPs 223 also configure the camera systems 108 and sensor systems 110. The physical layers 104 provide data 220 to the utility layers 102 via the communications links 370. The same communications channel 370 is also used to store any required physical layer 104 generated data in the RSDS 208.

The static VCPs 223 for the utility layers 102 of the system will configure the suite of algorithms 316 available for sensor and camera video/image processing. These algorithms 316 can be resident or they can be downloaded on the subsystem where utility layer operations take place. The static VCPs 223 for the utility layers 102 also contain data structures 322 and applets or agents 324, which are used to install parameters and operations in the utility layer algorithms 316. The utility layers 102 provide information to the abstraction layers 103 via the communications links 370. The same communications channel 370 is also used to store any required utility layer 102 generated information in the RSDS 208.

Still referring to FIG. 6a, the Static VCPs 223 for the abstraction layers 103 of the system will configure the suite of processes 326 available for processing initial information 227 obtained from the utility layers 102 of the subsystems. These processes 326 can be resident in the abstraction layers 103 or they can be downloaded on the subsystem where the abstraction layer operations take place. The static VCPs 223 for the abstraction layers 103 also contain data structures 332 and applets/agents 334, which are used to install parameters and operations in the abstraction layer processes 326. The abstraction layers 103 provide resulting information 230 to the application layer 104 via the communications links 370. The same communications channel 370 is also used to store any required abstraction layer 103 generated information in the RSDS 208.

The Static VCPs 223 for the application layers 104 of the system 100 configure the suite of applications: real-time analysis 233, statistical analysis 234, trend analysis 376, queries 235, data mining 236, and configurations 202. Most applications process information is obtained from the abstraction layers 103 of the subsystems. Initial system startup configuration applications 202 enable the system to run the necessary GUIs for the end-user administrator to configure the surveillance environment as part of the SU and the resulting preconfigured/static VCPs 223 so that we obtain the static VCP operations described here. These configuration applications 202 can be resident in the application layers 104 or they can be downloaded on the subsystem where the application layer operations take place. The static VCPs 223 for the application layers 104 also contain data structures 346 and applets/agents 348, which are used to install parameters and operations in the application layer applications 202, 233, 234, 235, 236, 376. The application layers 104 process information from the abstraction layers 103 and provide knowledge to the end-user via application GUIs 201 (as illustrated in FIG. 2). The same communications channel 370 is also used to store any required application layer generated knowledge 198 (as illustrated in FIG. 2) in the RSDS 208. This knowledge 198 includes alerts, responses, trend results, statistical results, data mining results, and other pertinent information that can be linked to abstraction layers 103 generated information 230, utility layers 102 generated information 227, and physical layer 101 data 220. This enables us to build a portfolio of learned information and knowledge to be used in the same system 100 or as part of loaded knowledge for the same class of systems in different SUs. This generated knowledge base thus becomes initially loaded information and knowledge base for the algorithms 316 of the utility layers 102, the processes 326 of the abstraction layers 103, and applications 202, 233, 234, 235, 236, 376 of the application layers 104.

As also illustrated in FIG. 6a, preconfigured/static VEPs 225 for the abstraction layers 103 of system 100 will configure the suite of processes 326 available for processing events as extracted from the information obtained from the utility layers 102 of the subsystems. These event processes 326 that run according to the VEPs 225 can be resident in the abstraction layers 103 or they can be downloaded on the subsystem where the abstraction layer operations take place. The preconfigured/static VEPs 225 for abstraction layers 103 also contain VEP data structures 352 and VEP applets/agents 354, which are used to install parameters and operations in the abstraction layer processes 326. The abstraction layers 103 provide information to the application layer 104 via the communications links 370. The same communications link 370 is also used to store any required abstraction layer generated information in the RSDS 208.

The difference between static VCPs 223 and static VEPs 225 in the abstraction layer 103 relate to the fact that static VEPs 225 include configurations capable of generating dynamic VEPs 226 and dynamic VCPs 224 as illustrated in recursive representation 380 and dynamic VCP generation indicator 382. Dynamic VEPs 226 are generated by other VEPs (both static 225 and dynamic 226) and provide the adaptive part of the method and system of this invention which enables the system to be able to incorporate changes in the surveillance environment (such as indicated by sensors) so that different VEP settings are used to extract the relevant events at the abstraction layer 103. Dynamic VEPs 226 also enable changes to the physical layer asset conditions so that system 100 can respond to changes such as a mobile platform (UAV, airplane, robot, etc.) and create new VEPs related to the changing location, conditions, or surveillance environment surrounding the platform, as will be described in more detail in the examples set forth below. Dynamically-generated VCPs 224 with their supported VCP data structures 312, 322, 332, 346 and applets/agents 314, 324, 334, 348 are generated to operate in support of static or dynamically generated VEPs 225, 226 so that as new dynamic VEPs 226 result, the corresponding new dynamic VCPs 224 for the changing environment result in updated VCP configurations for all layers. Examples of dynamically updated VCP configurations might include: change of settings for the physical layer 101 as in change in FOV for the cameras 108, change in camera mode to image intensification (II), change of threshold for sensors 110, and activating previously unused sensors 110; change of algorithms 316 for the utility layer 102; change of spatio-temporal abstraction processes 326 in the abstraction layer 103; change of presentation GUIs in the application layer 104 to reflect new environment or newly activated locations in the SU, change of data mining application 236 at the application layer 104; change of statistical analysis routines 234 for the application layer 104, and change of real-time analysis operations 233 at the application layer 104.

Furthermore, VCPs 223, 224 and VEPs 225, 226 function as follows:

At the physical layer 101 level, the VCPs 223, 224 configure all physical layer asset operations by setting operational parameters in each physical asset of the end-to-end system 100. Additionally, VCPs 223, 224 also configure and determine how much data 220 is stored locally, how much data 220 is transmitted or scheduled to be transmitted to the central RSDS 208, how much data 220 is archived, and overall management of the processing, storage, and communications assets of the local subsystem.

At the utility layer 102 level, the VCPs 223, 224 configure and schedule all utility layer algorithms 316 in each subsystem running the utility layer 102 and the associated physical layer 101 components related to it. Additionally, the VCPs 223, 224 also configure the filtering of initial information generated by the utility layer 102 and passed to the abstraction layer 103.

At the abstraction layer 103, the VCPs 223, 224 configure and schedule all the spatio-temporal abstraction layer processes 326 that run locally or centrally according to the subsystem where the abstraction layer 103 is running. Some local abstraction layer processes 326 may operate on a cluster of cameras/sensors processed by the same abstraction layer processes, while higher hierarchy subsystems may run spatio-temporal abstraction processes on multiple clusters of cameras. VEPs 225, 226 operate at the abstraction layer to determine which operations are performed on information resulting from abstraction layer processes 326, and comprising various operations to extract significant VCP and VEP configured events that are presented to application layer 104. VEPs 225, 226 in abstraction layer 103 also determine what events are passed in multiple classes also defined by VCPs 223, 224.

The VCPs 223, 224 in application layer 104 configure and schedule all applications to run in the application layers 104 running in the highest level hierarchy subsystems. The VCPs 223, 224 determine the type of operations performed by these applications on the information generated by the abstraction layers 103.

Also referring to FIGS. 6a and 6b, the VEP management, generation and alert application operations 190 perform the real-time management of VEPs 225, 226.

The VEP Management, Generation, and Alert Operations Application: An example embodiment of the VEP management, generation and alert application 190 (henceforth called VEP application 190) is illustrated in FIG. 6b. (For purposes of the following discussion, an agent program is referred to by the previously used name “agent.”) FIG. 6b illustrates that VEP application 190 processes VEP agents 354 and agent information, performs agent updates, generates new dynamic VEPs 226, generates new dynamic VCPs 224, updates states, and generates new states for these agents 354. Using the definitions found in the art for agents and environments (e.g., Chapter 2: Intelligent Agents, from the book Artificial Intelligence: A Modern Approach, by Stuart Russell and Peter Norvig, 1995, Prentice Hall, Inc.), an agent is comprised of an architecture and a program. In the preferred embodiments of this invention, agents 354 in VEPs 225, 226 or agents 314, 324, 334, 348 in VCPs 223, 224 are part of the architectural design of the definitions embodied in the VEPs 225, 226 and VCPs 223, 224 as comprised of VEP data structures 352 and VCP data structures 312, 322, 332, 346, with agent programs for VEPs and VCPs as already referenced in this paragraph with reference to FIG. 6a.

In reference to FIG. 6b, agent programs 354 in VEPs and VCP agents 314, 324, 334, 348 keep track of the perceptual system history in the SU environment. This history, which is captured in the RSDS 208 (not shown in FIG. 6b), is referred to hereafter as percept 384. This percept 384, as commonly defined in the art, is comprised of the saved state of each VEP 225, 226 and VCP 223, 224, and is stored in the distributed database storage RSDS 208. What an agent 354 “knows” about the environment is captured in its current state 386 and its percept 384. The VEP application 190 operates at least one agent 354 at a time depending on the number of systems available to run the SU. The VEP agents 354 access the percepts 384 stored in the RSDS 208 for that particular agent 354 and any other related agents 354. The percepts 384 are processed with the current state 386 of the agent 354 to update the VEP and perform any required VEP operations. If the termination criteria 388 of agent 314 is satisfied, the agent 354 terminates and the VEP application 190 moves to process another related agent 354. Otherwise, the process is repeated for the agent's new state 386 and updated percepts 384.

VEP agents 354 can take actions in response to any percept sequence. This includes generating alerts 172, 238 and dynamically generating new VEPs 226 and VCPs 224 in response to a real-time evolving situation or in response to stored information. These alerts 172, 238 are in addition to any other alerts resulting from other applications 202, 233, 234, 235, 236, 376 in application layer 104. The behavior of the VEP agents 354 is based on the agent's own percept 384 and the built-in knowledge from construction at initialization time, and modification or creation of agents in the VEP application 190. Therefore, the SU environment is completely ruled by VEPs 225, 226 and VCPs 223, 224 of the end to end system. Accordingly, the agent programs 354, 314, 324, 334, 348 in the VEPs and VCPs, respectively, comprise the complete operational definition of the SU environment.

Furthermore, the SU environment is generally considered accessible as all the percepts 384 for all VEPs 225, 226 and VCPs 223, 224 are available in the RSDS 208. In some cases, however, it might be considered inaccessible (e.g., due to lack of communications with a portion of RSDS 208) and, correspondingly, this condition is discerned by the agent programs.

Furthermore, the SU environment of this invention is considered deterministic because the next state of every agent 354 is determined by the current state 386, the percept 384, and the actions selected or performed by that agent 354. This means that every agent program 354 operates in a deterministic way from the point of view of that agent. Additionally, the SU environment is considered dynamic as the VEPs 225, 226 are designed to generate new VEPs 226 and VCPs 224 in response to evolving surveillance situations, such as when the environment is changing while an agent 354 is performing an action based on its available state 886 and percept 384.

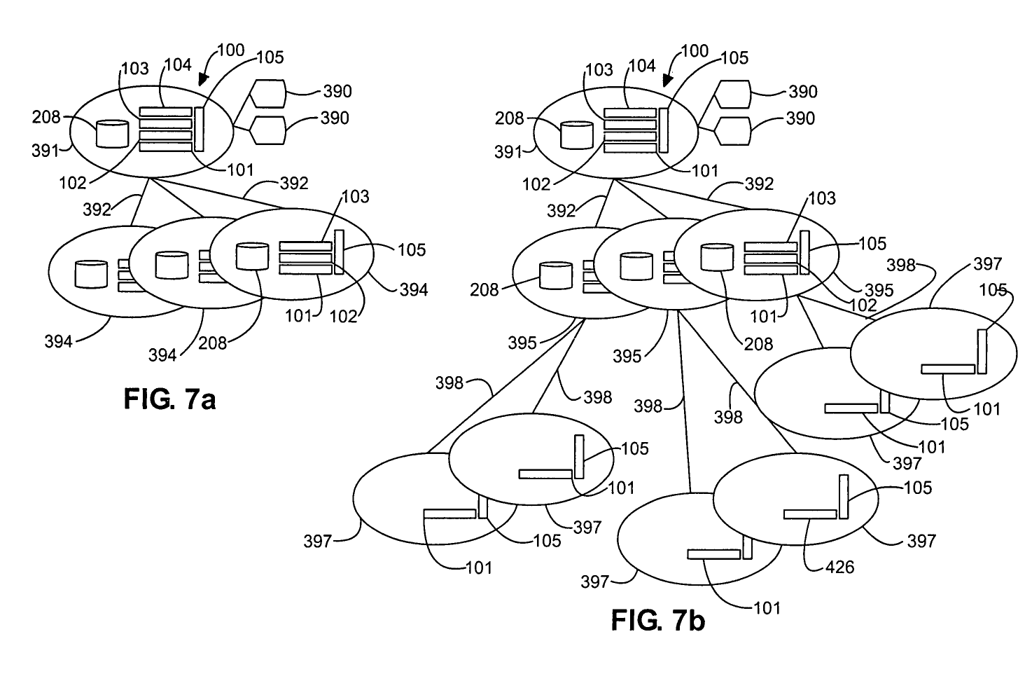

A Hierarchical Preferred Embodiment Implementation for the Method and System of this Invention: As we consider that the cost of physical layer 101 components drops so that the massive and pervasive deployments of sensors 110 and camera systems 108 becomes commonplace in multiple application environments, we organize the preferred embodiment implementations of the method and system of this invention as shown in FIGS. 7a and 7b. FIG. 7a illustrates the five layers of the method and system 100. The absence of any of the layers 101-105 correspondingly indicates that the layer is absent in the system or subsystem illustrated. RSDS 208 is a distributed RSDS, implemented by any means or combination of means of storage, which may include disk and/or other forms of random access storage. Displays 390 are provided for an end-user interface system, such as a personal computer that can run a multiplicity of GUIs for multiple purposes related to application layer operations. FIG. 7a includes a primary subsystem 391 comprising the previously described elements plus communications links 392 necessary to perform in a distributed and hierarchical fashion. The hierarchical system embodiment of FIG. 7a includes processing and storage in every subsystem 391, 394, and the hierarchical system embodiment of FIG. 7b includes processing and storage in higher hierarchy subsystems 391, 394, and much simpler lower hierarchy subsystems 398 without storage and with minimal or no processing.

FIG. 7a illustrates a two-level hierarchy for a distributed system 100. The hierarchy consists of a higher level subsystem 391 that incorporates storage for RSDS 208 and processing for all operational layers 101-105. Additionally, higher level subsystem 391 includes an interface to the end-users via suitable displays 390 which display GUIs for all end-user interfacing applications. Lower hierarchy subsystems 394 are linked to higher hierarchy subsystem 391 by communications links 392. Lower hierarchy subsystems 394 are comprised of RSDS storage 208 and layers 101, 102, 103, 105 that exclude the application layer 104 since these subsystems 394 do not directly interface to the end-user.

FIG. 7b illustrates a three-level hierarchy distributed system 100. The hierarchy consists of higher level subsystem 391 that incorporates storage for the RSDS 208 and processing for all operational layers 101-105. Additionally, subsystem 391 includes the interface to the end-users via suitable displays 390 to display GUIs for all end-user interfacing applications. Middle-level hierarchy subsystems 395 are linked to higher hierarchy subsystem 391 by communications links 392. Middle hierarchy subsystems 395 are comprised of RSDS storage 208 and multiple layers 101, 102, 103, 105 that exclude the application layer 104 since these subsystems 395 do not directly interface to the end-user. Lower hierarchy subsystems 397 are linked to the middle hierarchy subsystems 395 by communications links 398. Lower hierarchy subsystems 395 do not have storage in this example and only physical layer 101 and management/control layers 105. Lower subsystems 397 exclude the application layer 104, the abstraction layer 103, and the utility layer 102, thus retaining only the physical layer 101 and the management/control layer 105, since these subsystems 397 are very basic and all generated data is sent to the middle hierarchy subsystems 395 for storage in the RSDSs 208 of the middle subsystems 395, and processing by the rest of the layers in the middle and higher hierarchical subsystems 395, 391 of the system 100.

Those skilled in the art understand that the principles of this invention may be implemented in any suitably designed implementation of an automatic and adaptive surveillance system with the same fundamental hierarchy of the method and system of this invention. Further variations of the hierarchy may include multiple highest level subsystem members beyond a single system for purposes related to scalability, redundant implementations, hot-standby implementations, higher capacity implementations, and multiple command and control center subsystem implementations for multiple end-user populations in a networked environment.

Relational Surveillance Database System (RSDS): The RSDS is the distributed and relational database repository and operational storage for all of the configurations, VCPs, VEPs, all real-time sensor/video/image storage, and all the resulting information and knowledge for the system. The scope of the method described here enables operation of a surveillance operation in an automatic way through the setup of VCPs that can be dynamic and can adapt to utility layer processed sensor data from the camera and/or sensor systems and the abstraction layer processed information from the utility layer so that information can be presented in real-time or after the fact for a pre-defined or manually defined VEP. Each VEP has one or more profiles that describe the associated perimeter definitions. The profiles present information as identified in the elements of information described previously as database fields. Application layer applications or other VCP profile matching applications run through the information or database and obtain all the pertinent information and present it in an organized fashion to the end-user for real-time or after-the-fact analysis as resulting from these applications.

Collection of Information in a Distributed Relational Surveillance Database System: For effective operation of the system, according to the method of the invention, we include a mechanism to relate all the collected digital video and sensor information coming from the camera systems, all the sensors, all pertinent side information (e.g., location of cameras, location of sensors, PTZ camera settings, camera imaging modes, sensors modes, camera target positions, sensors locations, GPS or other geo-locational parameters, and the like) in such a way that it is all part of the RSDS with the proper field definitions. This enables the richness of the field definitions to characterize any and all queries and configurations of the system. The collection of the information need not be centralized but it could be distributed and still be accountable and reachable under the construction of the RSDS using known relational database art with distributed implementations. To implement such systems, we prefer hierarchical system embodiments such as those presented in FIGS. 7a and 7b. Two potential hierarchical embodiments of the system are presented in FIGS. 7a and 7b, which facilitate and enable all the necessary RSDS operations to support the method and system of this invention. In particular, in the hierarchical system embodiment of FIG. 7a with processing and storage in every subsystem, the RSDS 208 is distributed and relational in every instance and exists in every subsystem component. Using the communications links 392, 398 in each subsystem, RSDS 208 can run effectively as a seamless database using prior art operations of storing, retrieving, updating, synchronizing, and all pertinent relational and distributed database operations.

A Continuum of Information in Space, Time, Data, Information, Knowledge, and Static and Dynamic VCP and VEP configurations: The RSDS is the repository for all the spatio-temporal configurations and information pertaining to system 100, the spatio-temporal record of events that relate to activity detection, activity identification, and the configuration parameters for the systematic elements of the solution. This repository is a collection of all snapshots in time and location for all that happens in the automated surveillance system 100 and populated by the layered systems 101, 102, 103, 104, and 105 of the solution. At the heart of the system are the detectable, recognizable, and identifiable events as configured by the VCPs within the framework of the VEPs.

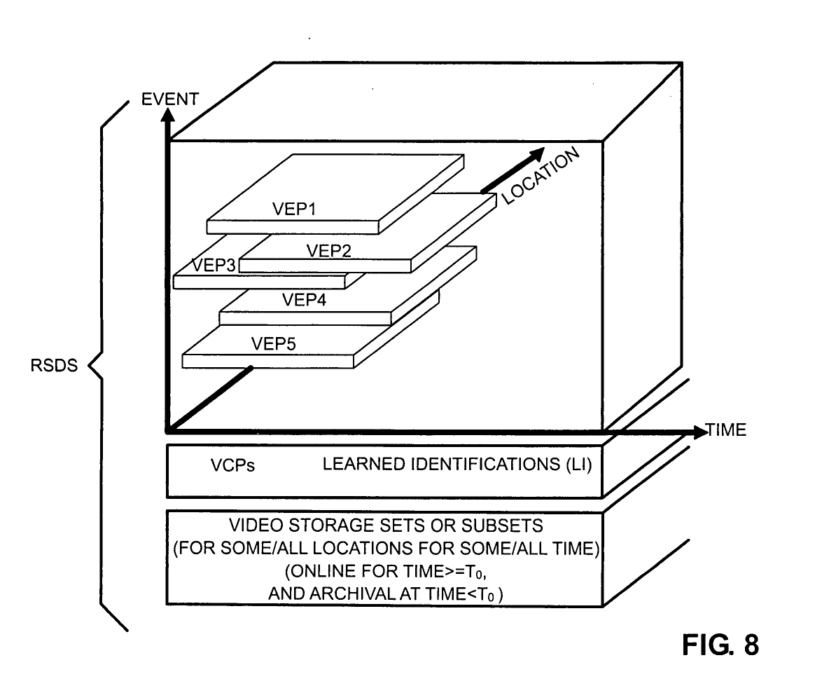

The resulting information for the purposes of configuration, operation, information capture, and information retrieval or rendition comes from a continuum of data and information that is all contained in the relational surveillance database as illustrated in FIG. 8. The richness of this RSDS comes from the flexibility provided by the VCPs and the VEPs in defining operands and operations associated with that continuum of information. The VCPs and the VEPs are profile driven settings with data structures and applets or agents that are used for the operation of the system and permit the gathering, processing, storage, and retrieval of the pertinent surveillance data and resulting information coming from the layered processes of the distributed system. The resulting information can then be turned into knowledge that is then usable by human operators in real-time or as part of a decision support process or automatic response. The representation of FIG. 8 is one of the embodiments of the RSDS that can be mapped into one or more possible GUIs for defining operations associated with the space, time, location, VCP configuration, VEP configuration, subsystem, and other considerations that are built as part of simple or complex queries and operations on the RSDS using distributed relational database applications and techniques applied to the distributed RSDS.

A system that incorporates Learning: The RSDS of resulting automated surveillance information can be analyzed for trends and statistical data, be mined for data in real-time or offline according to multiple configurable VCP directed application filter, relational, and other operational criteria to obtain trends and patterns of activities as defined by set rules. Operationally, and at all times, the fusion of data to information to knowledge based on triggered events in VEPs is used to refine its own dynamic generation of new VEPs and resulting VCPs so that evolving events can learn from seemingly unrelated events that happened in the same location, similar locations, or other locations at different times; or correlate seemingly unrelated events in different locations still within the same SU that are happening at around the same time. In this way, a global spatio-temporal RSDS 208 captures all the information pertinent to the target SU environment. Additionally, multiple non-linked surveillance systems in different SUs can create a database of learned data, information, and knowledge which can be provided as part of learned events passed from one system to another in similar deployments. Examples include but are not limited to force protection in peace-keeping missions where learned information related to unfriendly or suspicious forces, vehicles, vessels, activities, interactions, individuals, and sequences of events can be provided as learned information to any replicated surveillance systems in SUs. Similar learned events can be used in traffic surveillance applications where the learned events associated with accidents, high volume, bad weather, and the like, can provide reference information for the automatic activation of VCPs, VEPs, and provide not only end-user notifications to a command and control center but provide immediate automated system responses such as accident warning sign activation, lowered speed limit activation, bad weather sign activation, automated call for emergency vehicle response, and the like.

Further Examples of Preferred Embodiments of the Invention

### EXAMPLE 1

Perimeter surveillance with human activity, vehicle activity, water surface activity, underwater swimmer detection, and other sensor activity in a complex surveillance environment using VCPs and VEPs for automated surveillance system 100a.

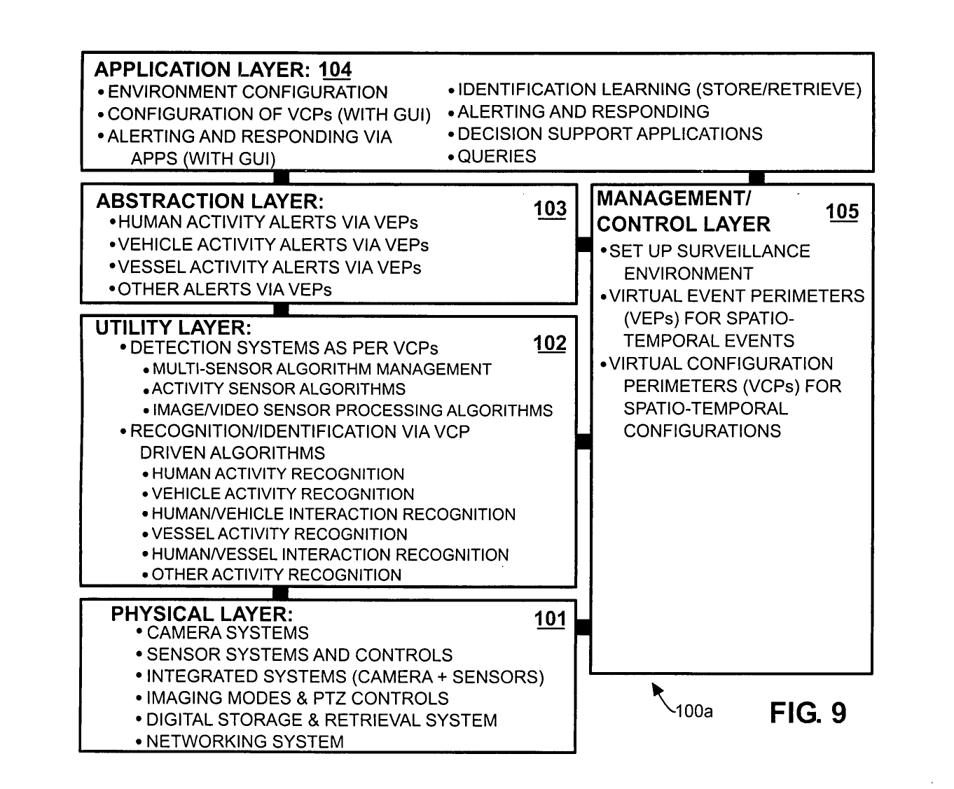

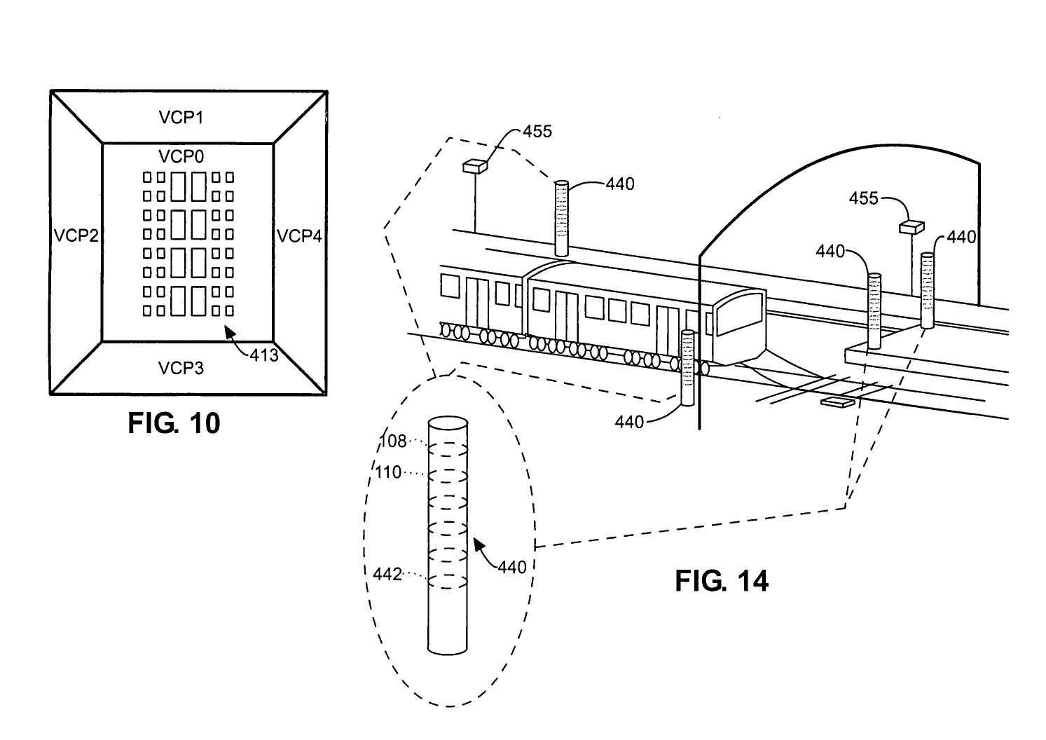

The challenge to provide force protection and infrastructure protection to significant port facilities, barracks, ships, building infrastructures, expansive military bases, and government buildings can encompass complex environments with threats that can come from land, water, or air. FIG. 9 illustrates a preferred embodiment of the layered processes associated with vehicle activity, human activity, human/vehicle interaction, vessel activity, and human/vessel interaction activity detection for a port facility. In this example, physical layer 101 is comprised of multiple camera and sensor assets distributed to provide complete coverage in a complex port facility that has land and water perimeters. As also illustrated in FIG. 10, the surveillance environment can be divided into multiple classes of VCP definitions in each area. Each area determines the parameters chosen to configure the physical layer assets in each environment. The type of algorithms to be used in the subsystems of each correspond to whether the area has water and/or land, the type of spatio-temporal abstraction processes that need to be performed to obtain alerts based on the VEP defined relationships among the information outputs from the utility layer 102 algorithms, and the applications chosen to present the resulting alerts according to analysis applications running operations on the resulting information from abstraction layers 103. FIG. 10 includes five VCPs, VCP0-VCP4, which can serve a typical force protection installation for a facility 413, and the VCP for each may contain specialized parameter configurations different from the others.

Based on the preferred embodiment of the method and system of this invention, system 100a can learn specific patterns of activity based on time, locations, sequence of events, vehicle classification, vehicle/human interactivity, real-time and offline application analysis, and the resulting classifications. Besides determining that certain patterns are not appropriate, such as multiple humans around a delivery truck that is supposed to have a single driver occupant, the system can learn that the bona-fide delivery truck is supposed to unload its cargo at certain periods of time, the duration of unloading, the size of the deliverables, and the actions and pattern of activity of the single driver occupant. The information learned is used to generate a new VEP that when triggered indicates a “non-alert” event while the absence of the event can also be triggered as an “anomaly” or a deviation from the event can be scored and determined to be statistically within the “green non-alert,” “yellow alert,” and “red alert.”

### EXAMPLE 2

Perimeter surveillance at night with human activity, vehicle activity, water surface activity, and other sensor activity in a complex surveillance environment using VCPs and VEPs for automated surveillance system 100b:

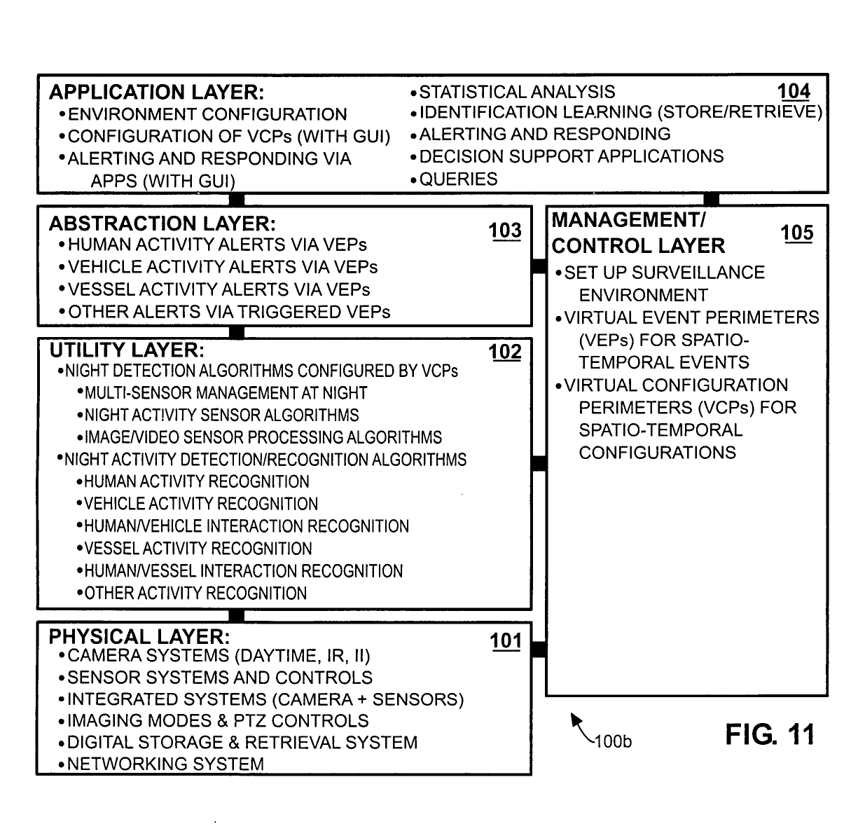

The challenge to provide force protection and infrastructure protection to significant port facilities, barracks, ships, building infrastructures, expansive military bases, and government buildings can encompass complex environments with threats that can come at night from land, water, or air. FIG. 11 illustrates a preferred embodiment of the layered processes associated with nighttime vehicle activity, human activity, human/vehicle interaction, vessel activity, and human/vessel interaction activity detection for a port facility. In this example, the physical layer is comprised of multiple cameras and sensors that are configured by VCPs with their nighttime configuration settings that are predetermined as part of the SU environment definition and configuration. Corresponding to the nighttime environment of the application, abstraction layer 103 VCPs have also activated the algorithms for nighttime activity detection. Furthermore, the VCPs and the VEPs for abstraction layer 103 operate with new data structures and relations to perform the spatio-temporal abstraction processes in the full space of the environment. Similarly, the applications in the application layer 104 are reconfigured by the VCPs to respond to perhaps more simplistic automatic response and decision support.

Based on the preferred embodiment of the method and system of this invention, patterns of human activity and vehicle activity at night are tracked automatically at the various layers 101-105 of the subsystems. Alerting and responding may be easier as most of the detection and classification work is done by the utility layer 102 algorithms. Similar to the previous example, certain patterns of activity can also be learned by system 100b, such as the run of the patrol vehicle because of the infrared signature of the vehicle, the track of the vehicle as it travels through various camera system locations and FOVs, the time of activity, the speed of the vehicle, the completion of activity, and so forth. Similarly, a statistical analysis application at the application layer 104 can automatically run the results and compare the information against accumulated information and determine that the results are OK or not OK for alerting or filing and anomalous “alerting” response (such as closing a gate) or result to the operator of the vehicle to contact the command and control center to get the gate opened.

### EXAMPLE 3

Automated Video and Sensor surveillance for trains, tunnels, and stations using VCPs and VEPs for system 100c:

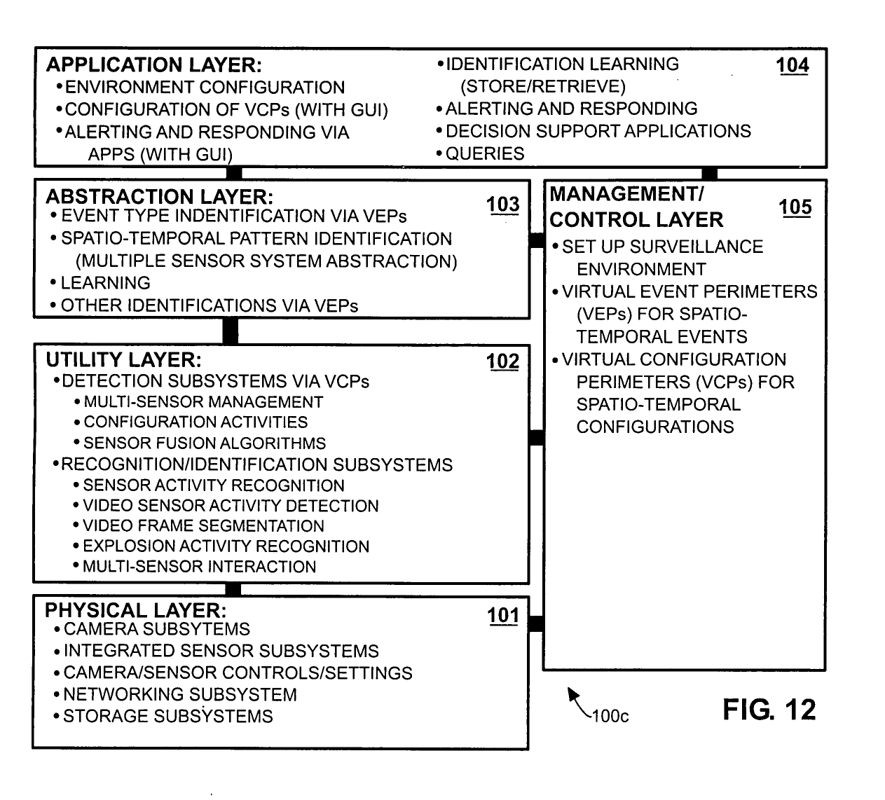

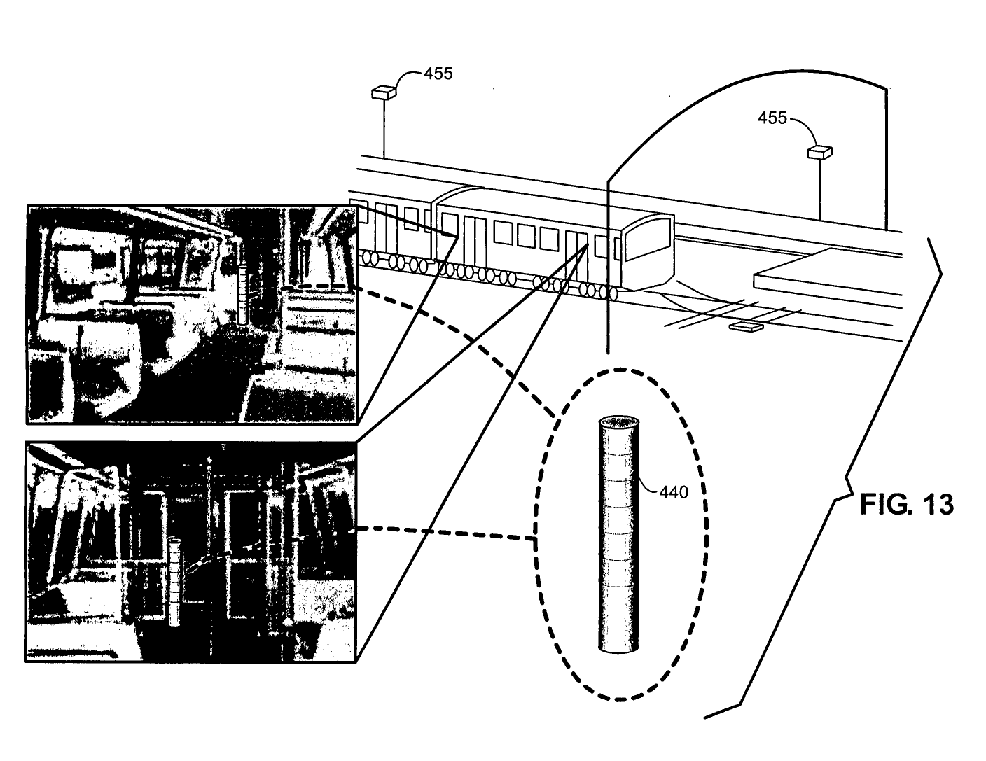

The challenge to provide protection from terrorist attacks in the train and subway systems of the major cities in the United States is overwhelming when considering the massive infrastructure and the complexity of the surveillance environment. FIG. 12 illustrates the preferred multi-layered embodiment of such a system 100c for the deployment of cameras and sensors in that environment. We divide the problem into two parts: the train environment as in FIG. 13; and the station and tunnel environment as in FIG. 14. These two parts must be served by the same system 100c in a complete SU environment where massively deployed cameras and sensors need to be run automatically and adaptively to the various conditions encountered at different times, and, particularly, during rush hour.

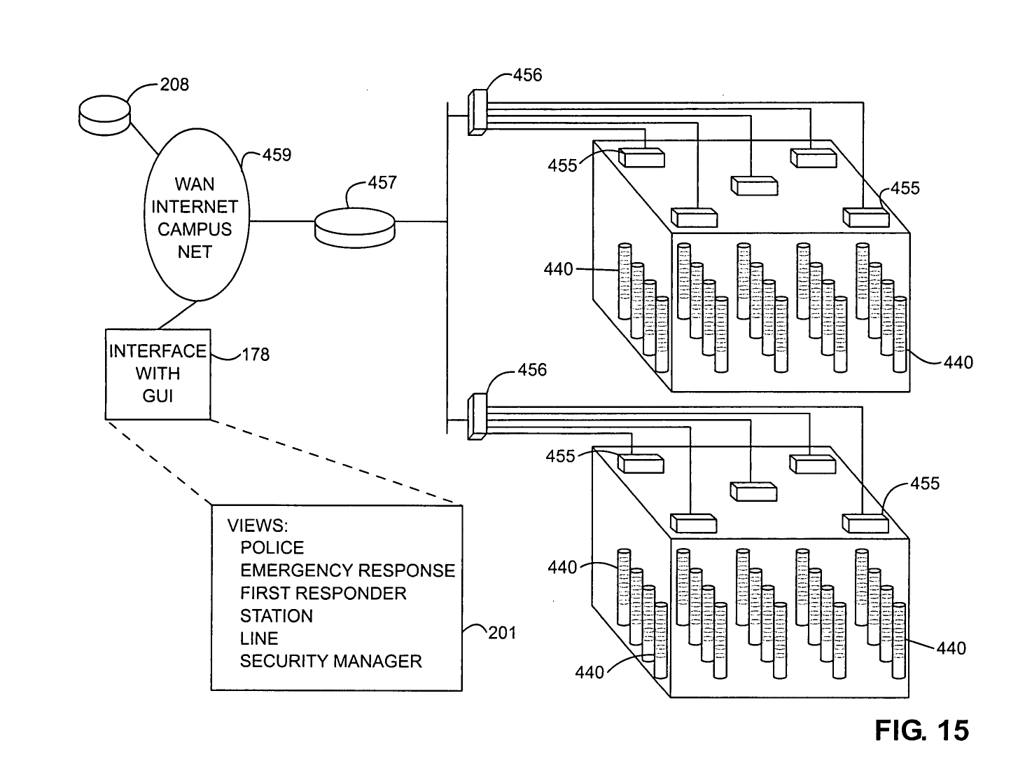

We must begin by considering that all the physical assets of the system 100c must be configured to operate with the correct parameter settings to minimize false alarms and maximize full coverage by the intelligent computing portions of the subsystems. We begin by paying close attention to the algorithms that run in the utility layers 102. VCPs are configured to include video segmentation algorithms to segment the various camera views between tracks, tunnels, and station platforms. Other views that need to be segmented are platforms areas that contain seating areas, stairs, hallways, garbage cans, and so forth. Additional algorithms operate on each of these frame segments to run group activity detection, vertical human position activity detection, prone position activity detection, human activity detection in the track, explosion detection algorithm, scream detection algorithm, and the like. Furthermore, as part of a simplified example, we have strategically located sensors such as seismic, sound microphones, etc., to provide a richness of data to be processed by the various algorithms in multiple locations. In particular, sensor pylons 440 are illustrated, and include multiple configurable sensors integrated into a pylon structure that is non-intrusive. Pylon 440 will be described in more detail in the next example, and as illustrated in FIG. 14, may include a functional set of sensors 110 and cameras 108 that can be controlled as part of the physical layer 101. In addition, pylons 440 may include wireless communications devices for communicating with system 100c, as also illustrated in FIG. 15. The communications network can include a plurality of wireless access points 455 located both in the stations and at points along the tunnels for passing data to system 100c, as will be described in more detail below with respect to FIG. 15. Sensor pylons can be positioned in train stations and tunnels, as illustrated in FIG. 14, and pylons 440 may also be positioned in train cars, as illustrated in FIG. 13, but less intrusive sensor mountings may be preferred in train cars, such as ceiling-mounted units, or other methods known in the art.

In addition, FIG. 15 illustrates the communications layout required to achieve the full wired and wireless networking connectivity necessary to be deployed as part of the hierarchical subsystems to implement this preferred embodiment 100c of the method and system of this invention. FIG. 15 includes a plurality of wireless access points 455, a plurality of level two switches 456, one or more routers 457 for the integrated surveillance network, a wide area network (WAN) 459, and an interface 178 with GUI 201. FIG. 16 shows a preferred embodiment of a sample GUI 201 for the operation of system 100c, which is designed to show significant events at multiple locations on a layout of a train system map 471 with some GUI windows 473 presenting video of the areas where significant events of various code level “red,” “yellow,” or “green” events have been triggered.

### EXAMPLE 4

Terrorist threat infrastructure protection using automatic and adaptive surveillance with VCPs and VEPs on integrated multi-sensor subsystems for a system 100d.

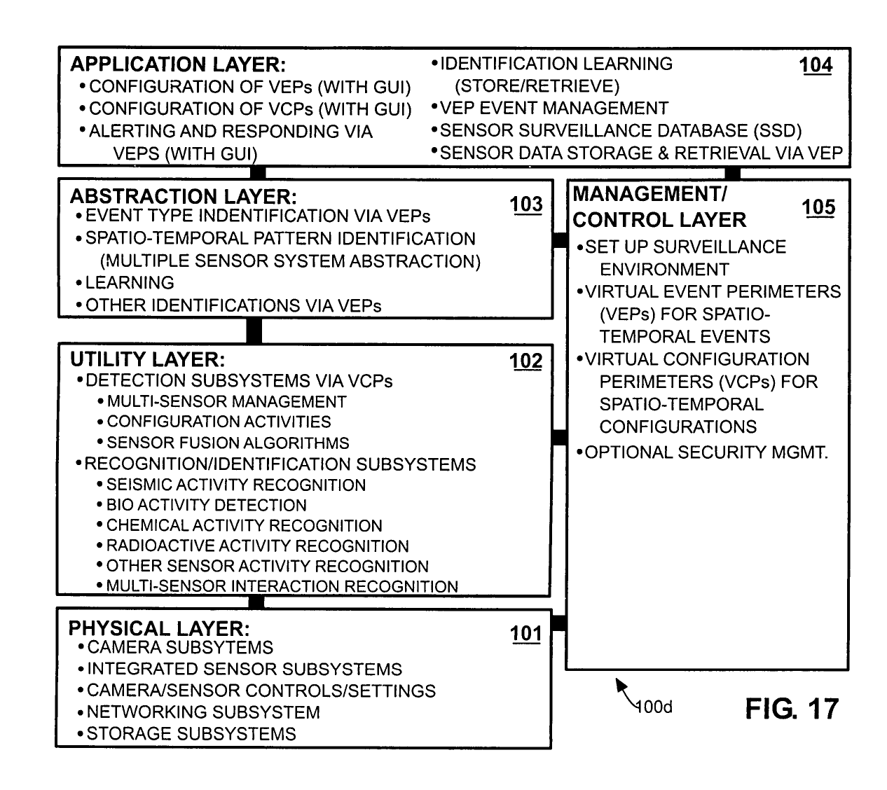

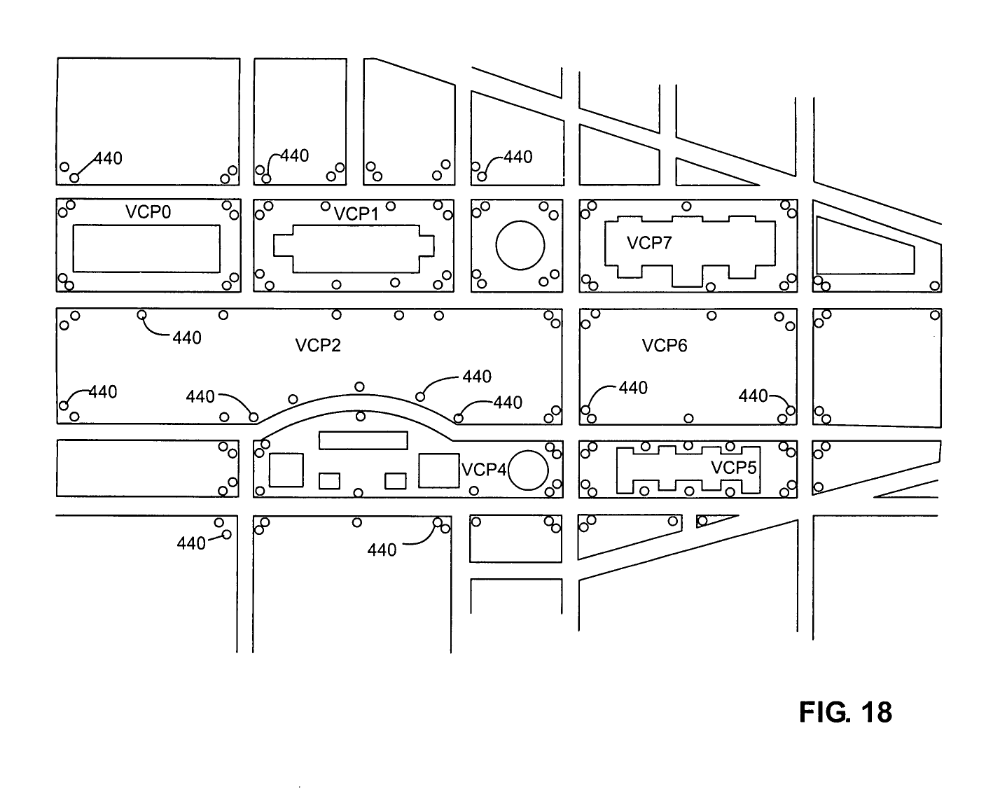

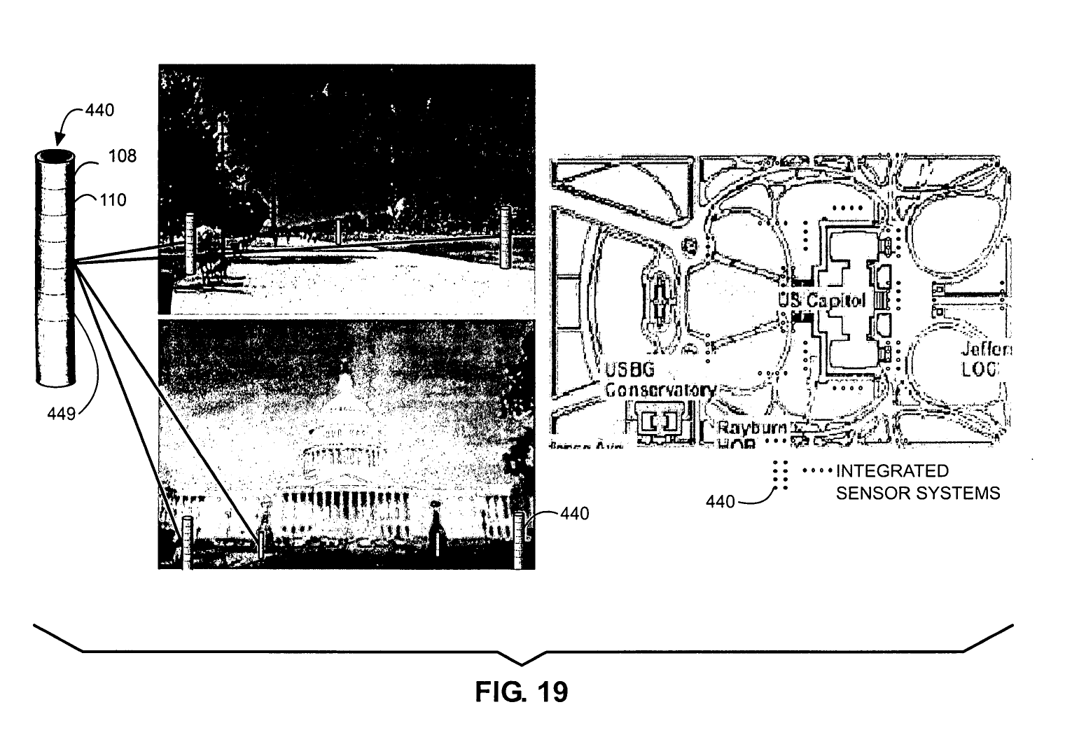

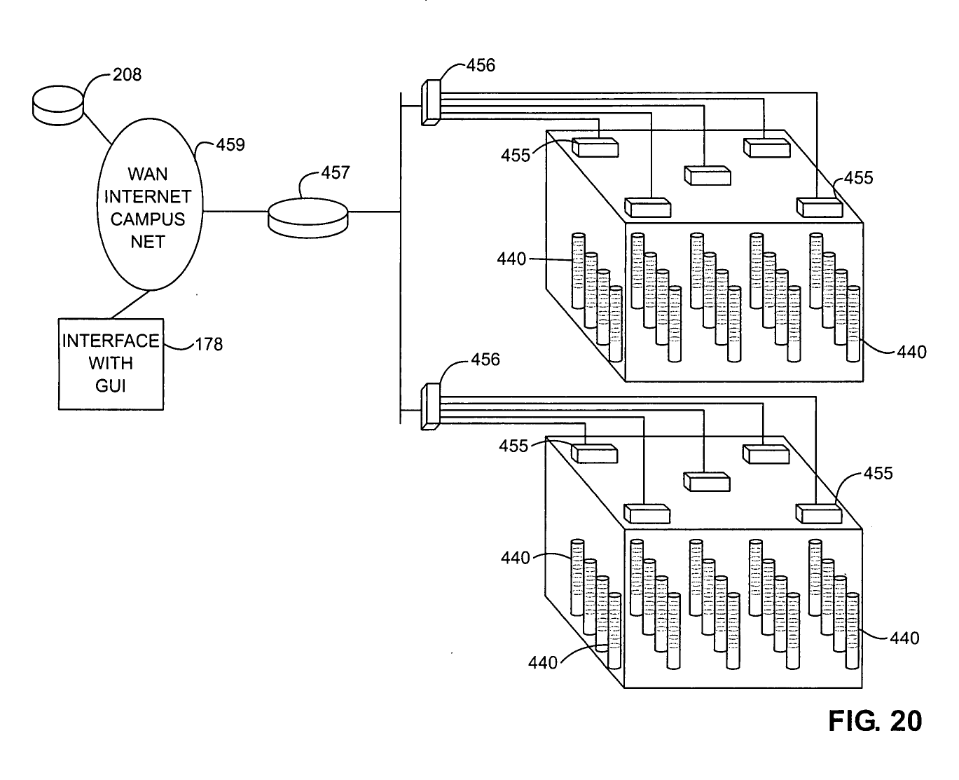

Protecting large campus environments with public government buildings from terrorist threats related to radiological, biohazards, or chemical agents can only be accomplished with massively and pervasively deployed systems of integrated sensors. These integrated sensors must be pre-configured according to different threat levels and surveillance environments. They must be non-intrusive and virtually eliminate false alerts while maximizing detection, mitigation, and containment of highly lethal agents. FIG. 17 illustrates the preferred multi-layered embodiment of such a system 100d for the deployment of sensors 440 in a large scale public building campus environment. We divide the environment as in FIG. 18 to cover all areas of the SU in this environment as also illustrated in FIG. 19. In one embodiment of the invention, multiple configurable sensors are integrated into a pylon structure 440 that is non-intrusive and can be physically designed to be a vehicle barrier as well as a functional set of sensors 110 and cameras 108 that can be controlled as part of the physical layer 101 to provide different settings for the various sensors according to different threat levels or other conditions that may affect the sensitivity of the equipment. These types of sensors are setup according to VCP configurations that result in window parameters, threshold parameters, minimum parameters, gated parameters, or combinations thereof. In addition, pylons 440 may include wireless communications devices for communicating with the system 100d, as illustrated in FIG. 20. The communications network can include a plurality of wireless access points 455 for receiving data from a plurality of sensor pylons 440. Wireless access points 455 are in communication with one or more level two switches 456, one or more routers 457 for the integrated surveillance network, a wide area network (WAN) 459, an interface 178 with GUI 201, and RSDS 208.

Moreover, in the preferred embodiment of this invention, each pylon 440 of integrated sensors contains a pylon subsystem 449 comprised of processor, storage, and communications. The subsystem 449 performs utility layer algorithms such as biohazard detection, chemical detection, and radiological detection. Other sensors such as microphones, IR sensors, or seismic sensors are also included to detect explosions, heavy equipment, or human activity, which are also configured by physical layer VCPs. The resulting information from the utility layer is processed for multiple sensor locations at the abstraction layer in a hierarchical implementation with configured VCPs and VEPs that can build a complete developing event profile to determine if a single radiation threat is real or an anomaly. For example, if a dirty bomb is exploded, the explosion information in any of the sensor locations, together with the first radiological reading triggers a VEP in abstraction layer 103 which results in an alert and perhaps an automatic response that sounds an evacuation notice, activates video surveillance cameras, and automatically calls hazardous materials responders. Other types of threats work similarly and depending on the SU environment, could deploy outdoor water spray sprinklers to mitigate a biological or chemical hazard event.

### EXAMPLE 5

Automated and adaptive vehicle tracking activity surveillance system using VCPs and VEPs for a system 100e.

Many closed perimeter and urban area environments present a challenge for force protection from vehicles that could be carrying bombs and other terrorist tools. Protecting these environments is performed with the heavy burden of inconveniencing all vehicle occupants who enter these areas. Using another preferred embodiment 100e of the method and system of this invention, we can configure physical layer subsystems comprised of camera systems, license plate recognition (LPR) systems, face recognition systems, and information about the drivers and occupants of such vehicles to minimize the inconvenience to frequent bona-fide users and perform checking for vehicles and occupants that are not part of a established database of knowledge for the system. Additionally, system 100e of this embodiment, can track every vehicle and build information and knowledge about all vehicles that enter the perimeter of the SU.

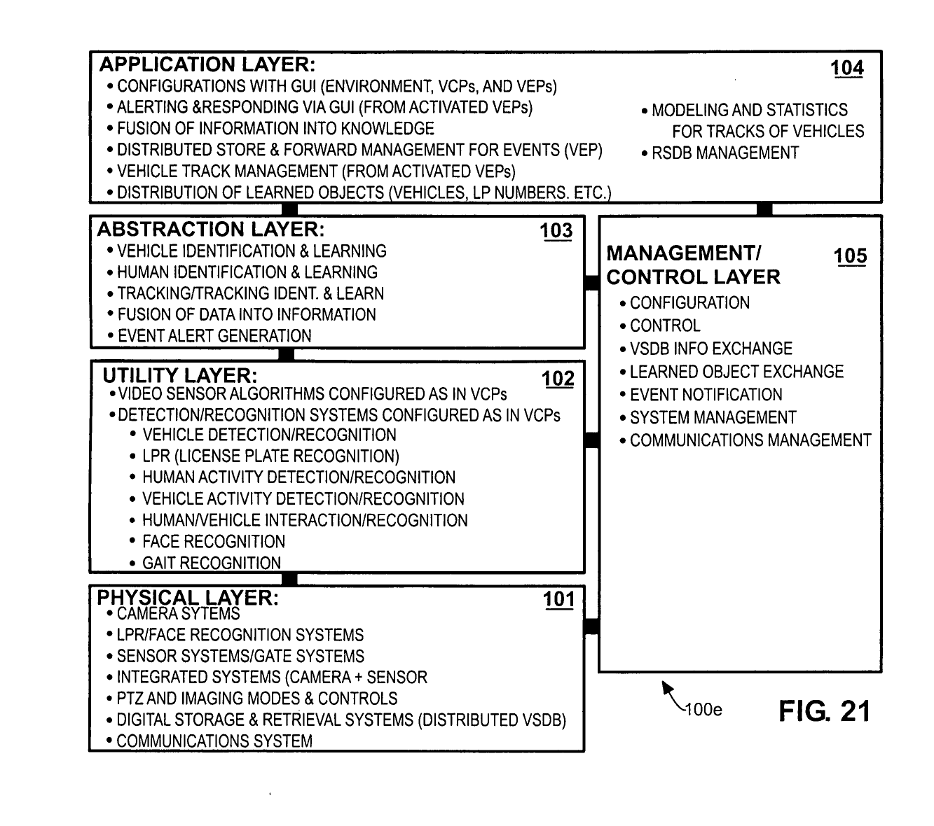

FIG. 21 shows an embodiment 100e of the multi layer subsystem whose physical layer assets, inclusive of cameras, sensors, LPR subsystems, storage subsystems, communications, processing subsystems, and gates, are all configured with physical layer VCPs. Furthermore, the utility layer algorithms are defined and scheduled by the VCPs of the utility layer 102. Multiple algorithms including automatic license plate recognition (LPR), verification of LPR with local information, identification of LPR with a local or remote department of motor vehicle database, face recognition and face storage associated with LPR, video frame segmentation and vehicle type detection, vehicle type recognition, vehicle activity detection, human/vehicle interaction detection, gait recognition, human activity detection, and other video sensor algorithms. The spatio-temporal abstraction layer configured with VCPs and event triggered VEPs takes care of tracking any given vehicle with LPR information, face recognition information, and vehicle type identification from one camera system to the next. The events triggered by the VEPs at the abstraction layer are used as track builders for such a vehicle. If the vehicle deviates from its non-allowed track, then another VEP is triggered and the proper alert and response is generated. However, a bona-fide vehicle that is generating the correct track and authorized track space within the SU will never generate a response alert because it is an authorized user of said perimeter.

This particular embodiment 100e of the method and system of this invention also facilitates the use of automated response subsystems such as single vehicle entry systems (with front and back gates) to automate access at off-hours, and to expedite “green” lane users during high volume hours. The tracking mechanisms configured at the abstraction layer via VCPs and VEPs build information and knowledge at the VCP configured application layers to facilitate the learning and building of knowledge about the users, the vehicles, the track patterns for all users. The automated and adaptive definition of new allowed tracks and multiple levels of security according to threat level alerts, traffic flow, emergency conditions, automated signage, and other SU environment conditions can be readily incorporated into the system by defining VCPs and VEPs that can be scheduled by a single command according to multiple RSDS database criteria that are invoked automatically based on an event or based on manual input from an administrator.

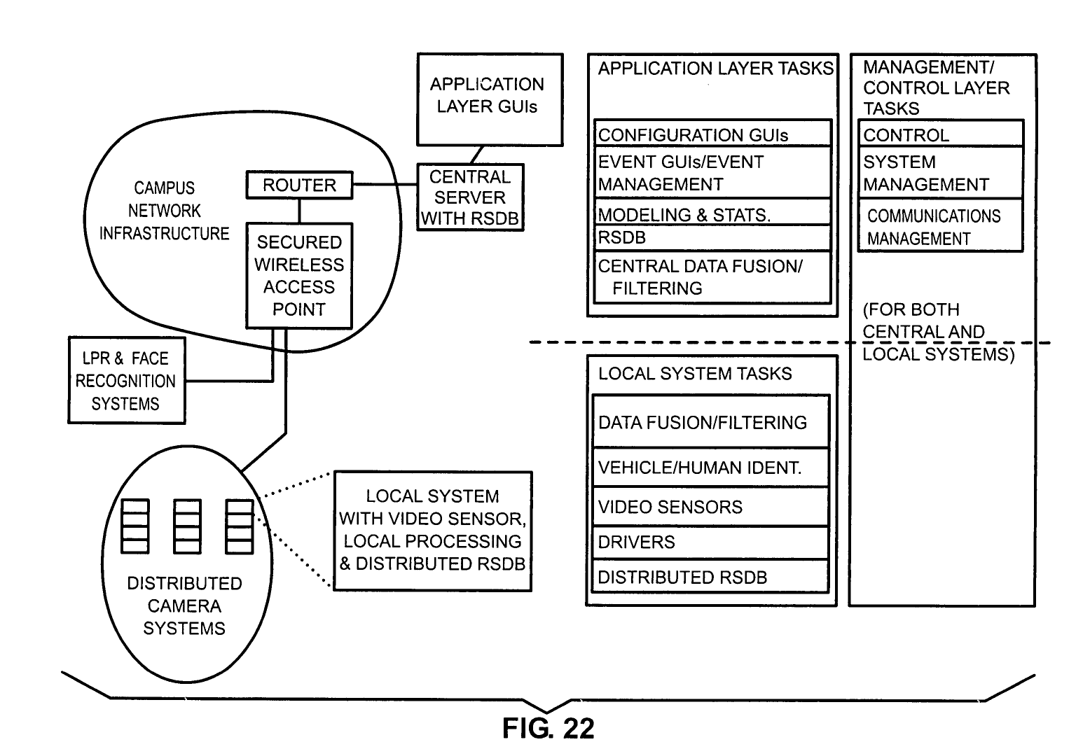

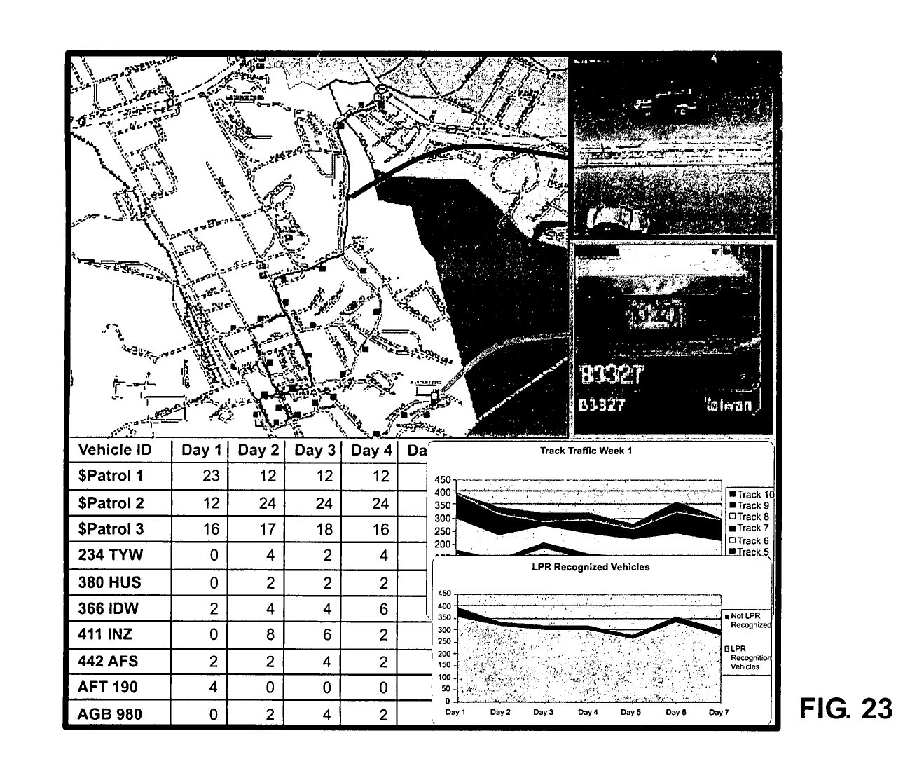

FIG. 22 illustrates the preferred embodiment of the subsystems of system 100e where the local processing with utility layer algorithms and local RSDS is co-located with the camera systems or clusters. These systems are connected via wired or wireless communications to a higher hierarchy subsystem that is comprised of the higher layer operations of the abstraction layer and the application layer to present all configurations and operational application interfaces with GUIs to the end-users. This higher-level hierarchical subsystem also contains the central RSDS. Other LPR and face recognition systems operate just like the local subsystem with their own processor and their own RSDS. FIG. 23 shows a preferred embodiment of a GUI associated with this automated surveillance system 100e which builds tracks and relates them to plate numbers and, through an application layer application, builds statistics on the track usage for vehicles in the SU.

### EXAMPLE 6

Crime surveillance application on the streets of a city with VEP definitions and VCP definitions for a system 100f.

The security environment of today demands that new and creative applications for surveillance systems be deployed to prevent, mitigate, respond, and prosecute significant crimes. One important example is the one associated with crime in a large city where many vehicles and people may be traveling through a street where there is no specific “physical perimeter” associated with that location or a crime event. In this example, the VCPs are static VCPs used to configure the surveillance subsystems in predetermined configurations appropriate to the SU associated with, for example, a high crime environment in a certain location with multiple physical layer platforms of sensors and cameras.

Given the specific crime event parameters such as location, time, and type of event related to other parameters (e.g., weather, such as snow where there are tracks on the ground, etc.), we can define one or more VEPs associated with the crime event. Each VEP in turn is comprised of one or multiple profiles that target a specific timeframe and specific space around the location of the event and the relational data from the database for all the data collected at the location of the event or in the vicinity of the event. The profiles are the VEP operands and they become the inputs to the data mining or matching application that will have a user interface for the definitions. The profiles contain data that permit the database to be searched with the parameters that get translated into camera locations for the VEP, camera angles for the VEP, cameras that were on at the time window of the VEP, and other VEP information. The results of the searches, data mining, and match applications are the subset of the data that becomes organized “information” that is presented by a suitable end-user application with the proper GUI to show all the ongoing activities at the VEP. This information will then be used by the end-user operators to create knowledge resulting from the crime event VEPs such as a picture of the individual committing the crime, the car used for the getaway, the license plate number of the getaway car, and so forth. Additionally, because all digital image and video are stored in frames, it can be further digitally processed in real-time or off-line to extract knowledge from the information (e.g., make of the vehicle, characteristics of the individual, license plate number of the vehicle, etc.). The resulting surveillance system 100f becomes the silent witness to the crime and the criminals.

Since a single crime can have multiple players and events associated with it, then multiple VEPs with corresponding multiple profiles can be defined to capture all the required information that results from the data captured by system 100f. For example, one individual could commit a crime but an accomplice could be lurking nearby in a getaway car to converge at the scene of the crime to pick up the perpetrator of the crime. The multiple VEPs could in turn be associated with an expanding time window, a specific time frame, and a specific space mapping where all the information coming from these VEPs is extracted from the relational database and presented in suitable form to the end-users. Additionally, since all camera system locations use multiple sensors and multiple PTZ settings, different VEPs could be configured taking advantage of the actual VCPs for that camera system as described below.

In this example, the VEP definitions and their associated operational profiles are very simplistic since there may be no prior knowledge of where the crime is going to occur. However, if there is any reason to suspect that there is a high probability that the crime will occur in a particular location, or there is a high state of alert/readiness for it, then the VCPs for higher quality video and more or different camera angles can be set up. Correspondingly, the results from the information extraction profiles in newly defined VEPs after the crime event has the resulting quality enhancements of the original operational profiles in the VCPs. The VCPs can be configured in multiple ways and are generated dynamically by VEPs adapting to the situation at the scene. For example, in the camera systems with multiple cameras, while one camera takes a wide angle view, another camera aimed in the same direction could provide the close up look (as in a highway access ramp) to provide more detailed information. Alternatively, the VCP could specify a single camera oriented towards that direction but through a higher quality and resolution video setting, it could still capture a wide angle view but with better quality resolution detail for further analysis in real-time or after the event.

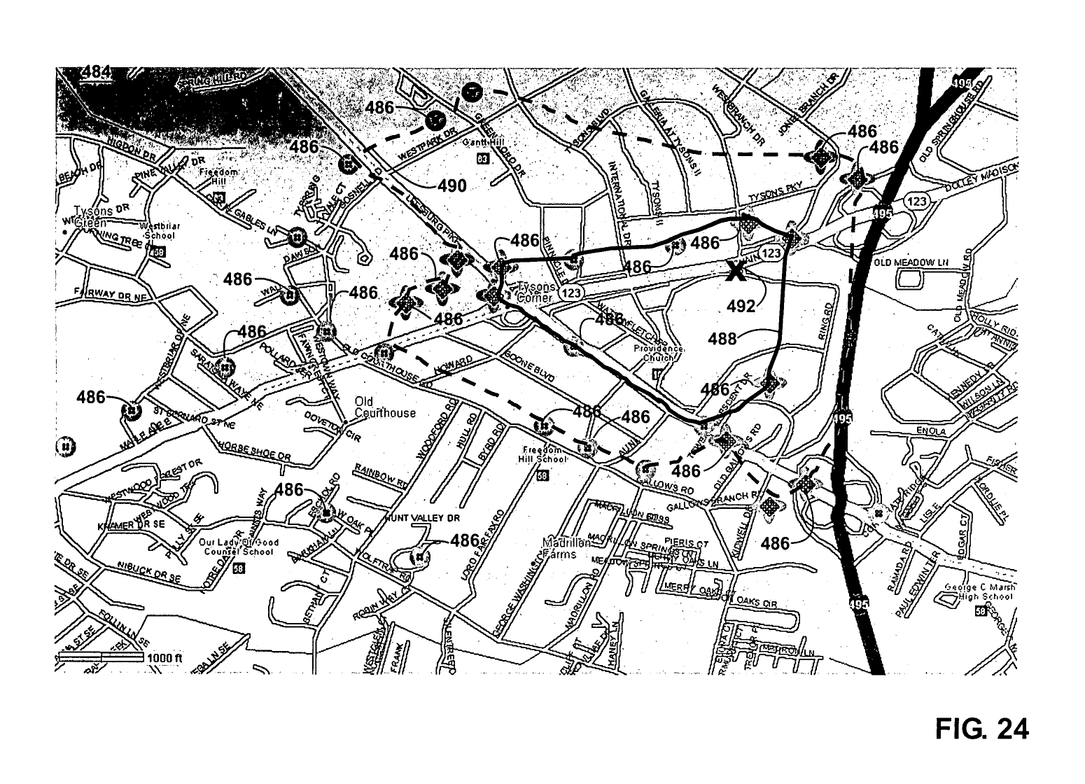

FIG. 24 illustrates an example of a city environment 484 where we are assuming that camera systems 486 with various sensors are deployed at key intersections for the purpose of the system and method described in this disclosure. All camera systems are configured for a state of readiness according to VCPs that are static or dynamic and influence the various conditions under which video surveillance information is presented and monitored in real-time to operators and for storage and later retrieval together with their associated information in a relational database. Also illustrated in FIG. 24, we have overlayed the definitions of two initially preset VEPs: a primary VEP 488 (shown in solid outline) and a secondary VEP 490 (shown in dashed outline) which have been defined in relation to a crime event 492 marked with an “X” location on the map.

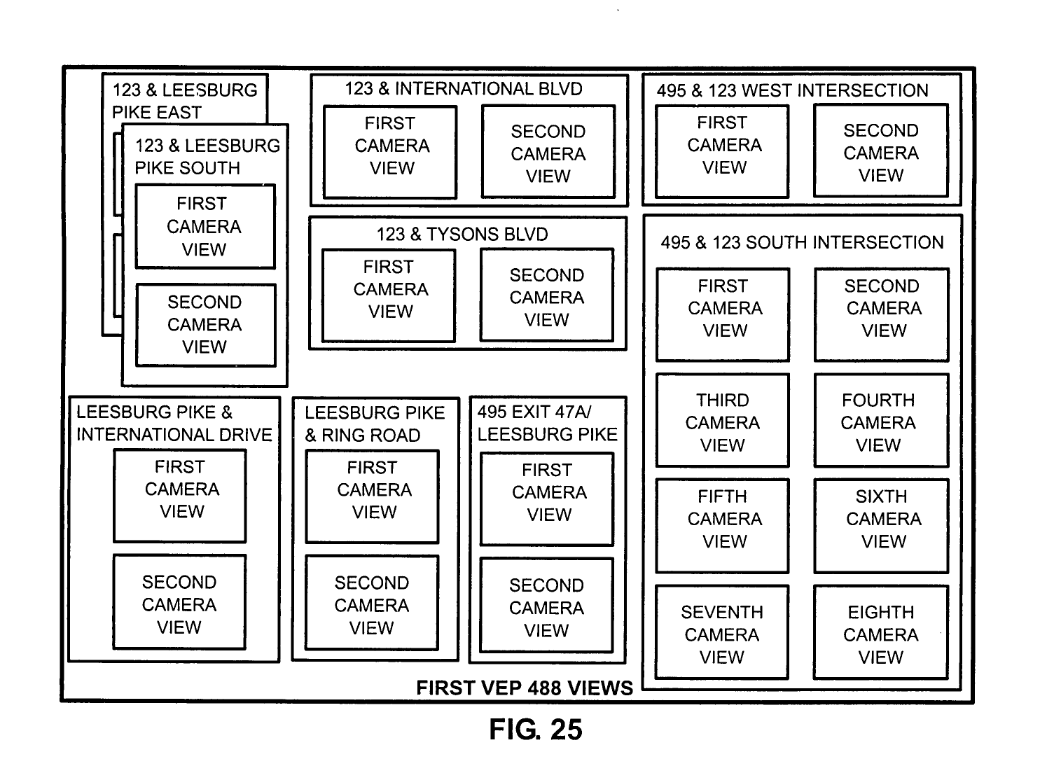

Given the crime parameters (e.g., a bank robbery with a getaway car of a certain description), then the first VEP 488 is set up with the proper time window (e.g., it can be current, as in from now until a user changes it, or it could be from ten seconds ago until a user tells it to stop, or it could from time x to x+10 minutes for a past event) so that all the information retrieved and associated with the VEP as shown in FIG. 24 can be displayed in a suitable GUI as exemplified in FIG. 25. The video information and ancillary information from the same relational database is then presented for analysis in real-time (e.g., during or immediately after the event). A secondary VEP 490 is also defined for this example (not shown in FIG. 25) but can be exercised with different time window parameters in the VEP profile so that a similar view can be presented and then information can be analyzed and knowledge extraction can occur. Further VEPs (not shown) can result from the initial information and more knowledge can be gained from the use of the method and system described in this embodiment 100f of the invention for analysis and decision support. Therefore a “rolling” set of VEPs can be developed to trace and track a particular vehicle or person within overlapping VEPs for presentation and analysis, in real-time or otherwise. In the case of rolling VEPs, the resulting VEP triggers and generates new VCPs and VEPs in the manner described with respect to FIG. 2, which are used in real-time tracking of the event and its actors in the full global spatio-temporal space of the SU (not just in multiple frames from the same camera view or adjacent cameras) through a highway, a whole city area, etc., where the massively and pervasively deployed camera and sensor systems of the SU are already deployed.

### EXAMPLE 7

VCP definition for physical perimeters and VEPs inside and outside a building structure for a system 100g.

Physical access control in many enterprises and government buildings (including embassies in other countries) are becoming an essential part of security applications in the current climate of terrorism and the urgent requirement to prevent, mitigate, respond, and prosecute any attempts or actual events. The method and system 100g defined here enables the creation of multiple VCPs associated with a fixed physical perimeter such as the outside of the building. Moreover, multiple VCPs associated with the same physical perimeter can be defined that have different profiles associated with changing environment conditions related to various surveillance environment sensor conditions, various time of day conditions, various weather conditions, or various states of alert or readiness. For example, different times of day or days of the week demand that the same physical perimeter be under surveillance but under different sensor parameters, different qualities of the data, different visual camera modes, or different cameras and different camera mode control positions.

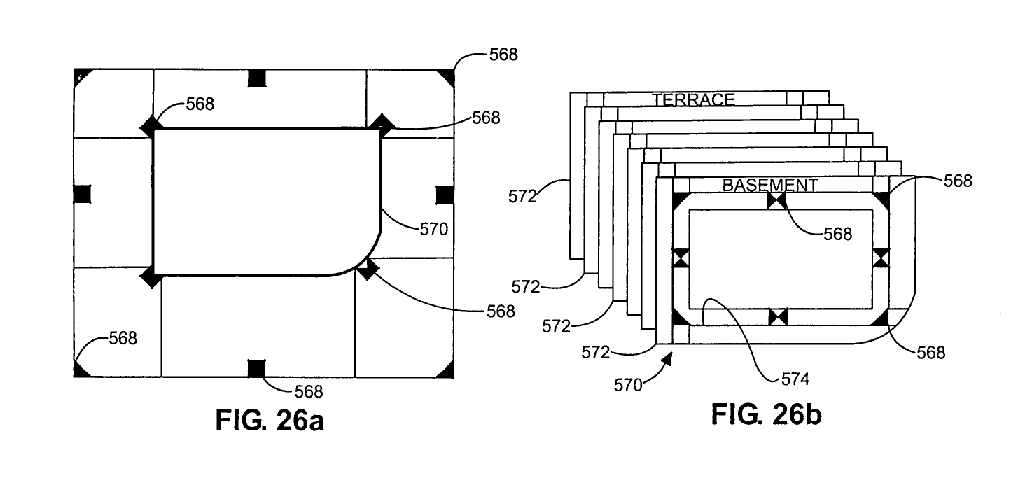

Similarly, the insides of the building are not usually associated with a given physical perimeter, but multiple cameras at the ends of corridors or in the stairways, can allow the definition of VCPs for the same parameters identified above or for different security levels for the different floors or for access to more secured areas that occur at different times of the day (e.g., bank vault floors at non-office hours). FIGS. 26a and 26b show a typical configuration for a simple building configuration with FIG. 26a illustrating external application and FIG. 26b illustrating an internal application. In FIG. 26a, a plurality of camera, sensors, or integrated camera/sensor units illustrated as surveillance devices 568 are positioned on the exterior of building 570 for providing surveillance coverage. Each surveillance device 568 has a preconfigured coverage area, as specified by the VCPs. Similarly, in FIG. 26b, the interior of building includes seven floors 572, with each floor 572 having a plurality of surveillance devices 568 positioned in the hallways 574 and other predetermined areas.

VCPs in this example are used to set the operational settings to record and to be able to analyze information during or after the fact through the use of VEPs. VCPs define the operational characteristics of the surveillance system for pre-specified or later defined VEPs that may arise from the analysis of an event in real-time or after the event. A fully automated system can be implemented where VEPs can be generated but another VEP associated with a biometric reader to ascertain the identity of the human that activated the first VEP can make the first VEP a “non critical” or even an “OK event” by virtue of the fact that the biometric sensor event configured in another VCP generates the second biometric event VEP that qualifies the first VEP and renders it non critical at the application layer.

While the VEP example mentioned above demonstrates how multiple sensor processing algorithms in the utility layer (such as the biometric sensor algorithm) and the abstraction layer process to compare biometric identification or verification against a database, VEPs are also configured for global spatio-temporal abstractions at the abstraction layer in the SU. For example, using physical access systems that provide sensor information at the physical layer, we can recognize information resulting from the utility layer related to the identity of an access card holder. Given this identity, the information will be processed by VCPs at the abstraction layer and a specific VEP setup to make sure that the person whose identity has been resolved can only access a specific floor, elevator, or room according to the access card sensors and the VCP profiles associated with that person.

External VCPs and VEPs can be configured to trigger automatic events and alerts that track people or moving objects as they move in or around the perimeter of the building. While the utility layer uses video sensor algorithms (e.g., to identify activity, track a moving object in a FOV, and provide image segmentation for the same algorithms) and other sensor algorithms (e.g., human heartbeat detection, infrared signature detection to differentiate from non-animal objects, microphone sound signatures for walking/running humans, etc.), the abstraction layer provides spatio-temporal abstractions to perform further tracking in space and time based on the information from the utility layer to place the resulting information in a time and space framework that can be processed by the abstraction layer to compute if the tracked person or persons continue in the SU perimeter, have approached the building and are attempting to enter the building, or have entered and subsequently left the SU perimeter. Multiple algorithms and multiple processes have been developed in the prior art for the utility layers and the abstraction layers of the method and system of this invention. Given a set of these algorithms and processes with modern software interfaces, we can implement VCP and VEP structures to schedule and run these algorithms and processes automatically and adaptively. Similarly, the application layer processes of GUIs and analysis applications are used to present the real-time alerts, the learned events, the stored events; and to configure the systems and SU environments as in this example to present specific types of alerts, and to automate responses such as turning deterrent systems on.

### EXAMPLE 8

Force protection in a hostile environment or drug trafficking mitigation solution of system 100h.

The warfighter will face new challenges in future combat operations that are changing from traditional combat roles to highly hostile “peace-keeping” missions such as those in Bosnia, Afghanistan, and Iraq. These operations demand new solutions that provide continuous automated and adaptive video and sensor surveillance coverage for decision processes that are derived from real-time and non-real-time analysis of information and knowledge derived from the information obtained from flying platform camera systems mounted on UAVs or OAVs. These may include massively, pervasively, and strategically deployed sensors or clusters of sensors at key locations (e.g., ground based unattended sensors and video or imaging units). The resulting real-time data obtained by the layers of the systems is processed to provide alerts, warnings, decision support, and response support to the end-users. Such systems mitigate surprise organized attacks by unfriendly forces whose activities can be monitored by the algorithmic processes of the utility layers, analyzed in real-time at the abstraction and application layers, so that the system 100h may issue alerts and warnings through the application layers. The VCPs and VEPs in this preferred embodiment are activated according to the configurations that are programmed by end-users of the system and alerts/warnings knowledge presented directly to the end-users with simplified GUIs.

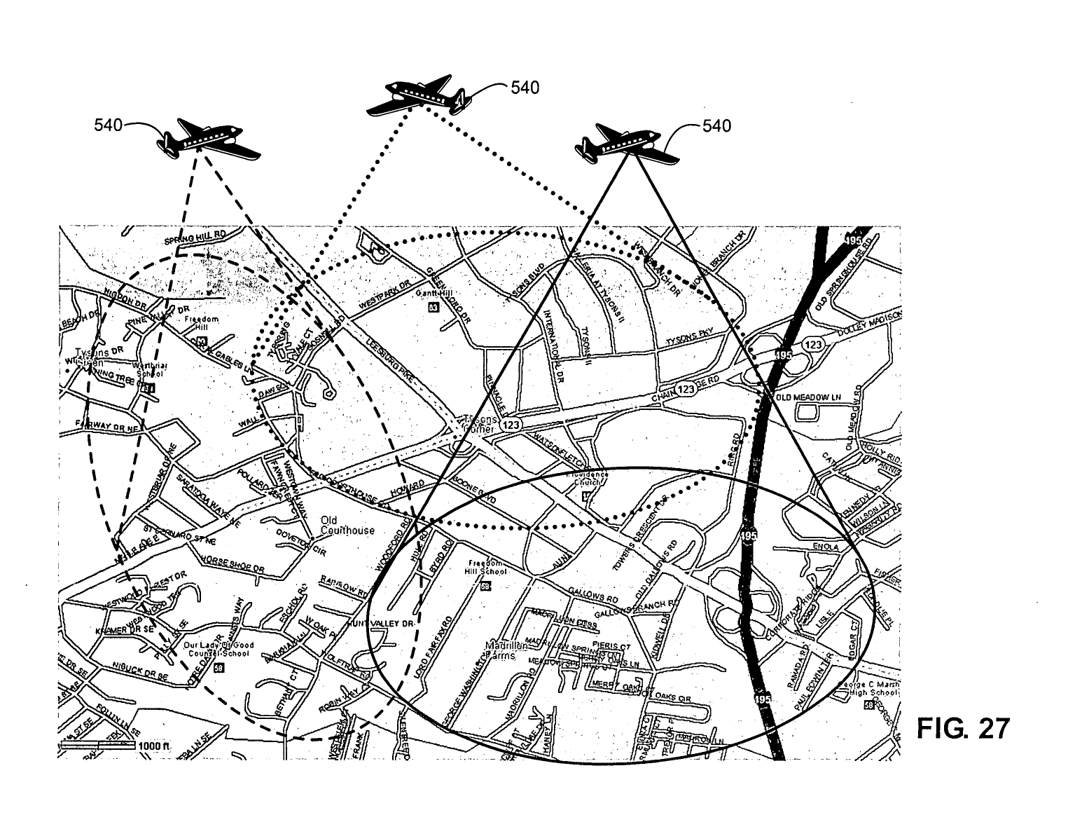

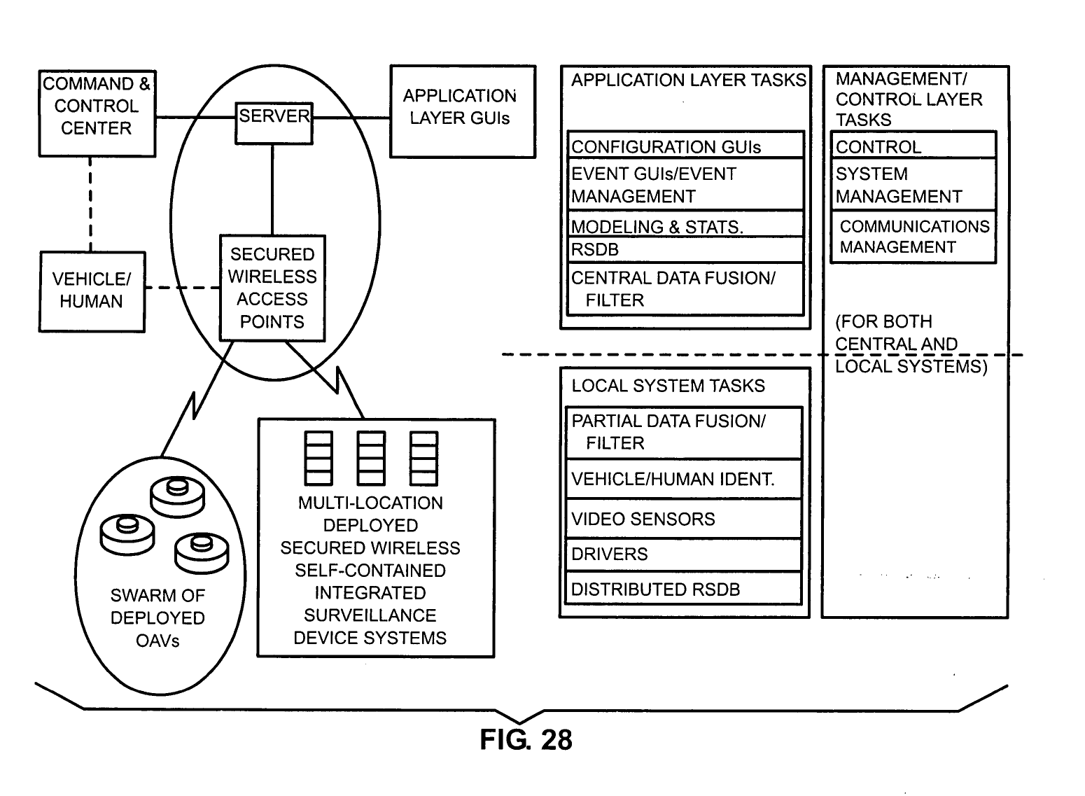

A similar solution as shown in FIG. 27 is required for drug trafficking mitigation in urban or remote environments where continuous surveillance is provided with the help of multiple manned or unmanned loitering air platforms that cover multiple sectors at different periods of time. They could also include a rotating deployment of flying platforms at predetermined locations (e.g., hostile urban areas, remote areas, etc.) with the same configurations and learned events contained in the end-to-end distributed system 100h comprised of the subsystems and the relational RSDS. FIG. 28 shows an embodiment of the invention where organic air vehicles (OAVs) 590 and strategically located ground-based physical layer platforms 592 are deployed for building a SU automatic and adaptive surveillance application system. Consistent with physical layer platform limitations, we may have an instance of a preferred embodiment of the invention as in FIG. 7b where a three-level hierarchy of subsystems are implemented to build the end-to-end system. Furthermore, we can also combine with the two level hierarchy for those subsystems that are capable of bigger physical layer payloads (that is, including storage and processors) to provide processing and storage for the RSDS.

FIG. 27 shows a solution embodiment of the invention where three VCPs are defined for coverage by the loitering flying platforms 540 equipped with camera and sensor systems. The camera systems can contain multiple imaging capabilities and options (e.g., infrared, thermal, low-light, flash-sensitive, high-resolution, etc.) that are exercised by the VCP profiles. The flying platforms 540 are fixated on the sector coverage even when moving around by the use of tracking technology that stays with the target sector regardless of flying platform 540 attitude, altitude, location, and position. Furthermore, through the use of one or several means (invisible laser, GPS, gyroscopic positioning, etc.), a flying platform 540 can loiter on target for the duration defined by the VCP until a newly generated dynamic VCP target profile parameter is presented or defined. FIG. 27 illustrates how the sectors could overlap to provide full coverage for a larger area. Additionally, all three flying platforms 540 in this example could be targeting the same sector but under different VCP parameter profiles, as in different imaging modes, because each flying platform 540 can have dedicated camera and sensor system payload capabilities and capacities. However, all the digital video and sensor information as per the method of this invention is captured in a related way as part of the RSDS regardless of which platform 540 it is coming from. The algorithms at the utility layer operate in the platform using a processing subsystem to perform the algorithm operations and relay information to the higher hierarchy in the system that resides in a command and control center and provides the rest of the layered processes: abstraction layer and application layer. All subsystems have an instance of the management/control layer which takes care of static and dynamic VCP and VEP configurations.

Furthermore, the use of ground sensors and/or imaging complementary to the flying platform 540 sensors and imaging and all their respective physical layer information are also encompassed by the same distributed VCP definitions. These can trigger VEP definitions, which are in turn used to generate new VCPs and/or VEPs for the flying platforms to derive full SU spatio-temporal tracking of “friendly” or “unfriendly” forces and force movements so that “critical” and “non-critical” events are generated and proper alerts, warnings, decision support, and response support is provided to the end-users.

To aid in the real-time operational deployment and support, VEPs can be defined once a specific moving target is identified and multiple generated VEPs in a “rolling configuration” can be deployed so that resulting VCPs (which also contain navigation and positioning configuration information for the flying platforms 540 since they are also part of the physical layer) enable flying platforms 540 to follow the motion of a target or target groups in real-time. For example, utility layer algorithms that process groups of people or groups of vehicles can be used to track them within a single UAV, while the abstraction layer processes can correlate all the information obtained from the utility layers of the subsystems and provide the spatio-temporal tracking and directions across multiple areas of coverage corresponding to different locations and different physical layer UAV platforms. Alternatively, multiple flying platforms 540 could be available and spare flying platforms could be preemptively positioned in the direction of track in advance of the resulting motion and, correspondingly, the target of the VCP configurations is the new flying platform and all the equipment in that physical layer. Dynamic VEPs are then used to continue with the same type of event tracking associated with one or more targets that are being tracked within this evolving SU application.

In the drug trafficking application, multiple VEPs can be defined for after the fact analysis and presentation of all the relational database data. This could consist of multiple imaging views of the same target, but under different imaging capabilities. Views, for example, could include the scene in low-light and a thermal version of the same to show that the car was just turned off, bales of drugs were thrown from the vehicle, and they were picked up at a given location by a police car for evidentiary purposes.

For the force protection in hostile environments embodiments, multiple flying platforms laden with sensor/imaging equipment together with ground-based sensor/imaging equipment can now work cooperatively as part of one seamless system by virtue of this invention, which encompasses all configurations via VCPs and VEPs, events via VEPs, adaptations and learning via dynamically generated and evolving VCPs and VEPs, and just-in-time surveillance knowledge alerts, warnings, decision support, and response support.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Combinations of the above embodiments, and other embodiments not specifically described herein will be apparent to those of skill in the art upon reviewing the foregoing disclosure. The scope of the invention should properly be determined with reference to the appended claims, along with the full range of equivalents to which such claims are entitled.

The invention claimed is:

1. A method for operating a surveillance system in a surveillance environment, the method comprising:
providing a plurality of surveillance devices in the surveillance environment for gathering surveillance data, thereby producing gathered data;
establishing a virtual configuration perimeter for the surveillance environment, said virtual configuration perimeter comprising configurable parameters for operating said surveillance devices;
providing a relational database containing information;
establishing a virtual event perimeter comprising at least one event-driven agent that is an object of said gathered data, whereby said gathered data is related to said information in said database for generating an automated response.

2. The method of claim 1 further including the step wherein said virtual event perimeter establishes a new virtual configuration perimeter based upon the operation of said at least one event-driven agent and the relation of said gathered data to said information in said database.

3. The method of claim 2 wherein said step of establishing a virtual configuration perimeter includes the step of establishing a virtual configuration perimeter that comprises profiles comprised of data structures and agents that allow multiple layered processes to be configured and scheduled according to operational characteristics of the surveillance system.

4. The method of claim 1 wherein said automated response includes the step of generating a new virtual event perimeter, said new virtual event perimeter controlling at least one event-driven agent that is different from the original event-driven agent.

5. The method of claim 4 wherein the step of generating said new virtual event perimeter includes the step of generating said new virtual event perimeter recursively so that said new virtual event perimeter may recursively generate additional new virtual event perimeters.

6. The method of claim 1 further including the step of organizing the surveillance system into layers, wherein a physical layer includes physical components of the system, a utility layer includes utility algorithms of the system, an abstraction layer includes abstraction processes of the system, an application layer includes applications of the system, and a management/control layer includes a control means for the system.

7. The method of claim 6 further including the step of including said virtual event perimeter and said virtual configuration perimeter in said management/control layer, whereby said virtual event perimeter and said virtual configuration perimeter may be provided by the management/control layer to the utility layer and the abstraction layer.

8. The method of claim 6 further including the step of providing both off-the-shelf algorithms and system-specific algorithms in said utility layer for performing utility operations on and controlling the gathering of said gathered data by said surveillance devices.

9. The method of claim 6 further including the step of providing processes in said abstraction layer for performing spatio-temporal processing of said gathered data.

10. The method of claim 6 further including the step of providing a graphic user interface in said application layer for interfacing with a user for configuring the surveillance system.

11. The method of claim 10 further including the step of the user operating said graphic user interface to manually configure said virtual event perimeter and said virtual configuration perimeter.

12. The method of claim 6 further including the step of providing a data mining application in said application layer for extracting data from said database for obtaining extracted data and relating said extracted data with said gathered data for producing said automated response.

13. The method of claim 6 further including the step of providing an analysis application in said application layer for performing at least one analysis operation on said gathered data, said analysis operation being chosen from real-time analysis, statistical analysis, and trend analysis.

14. A method for an adaptive surveillance system for automatically responding and adapting to events in a surveillance environment, said method comprising:
disposing at least one surveillance device in the surveillance environment;
operating said at least one surveillance device in accordance with at least one pre-configured profile for gathering surveillance data;
providing operands for examining said surveillance data in comparison with a relational database to extract events; and
reconfiguring at least one of said at least one profiles to adapt said at least one surveillance device in response to said events.

15. The method of claim 14 further including the step of changing said operands in response to said events for extracting additional events.

16. The method of claim 15 wherein the step of changing said operands includes the step of changing said operands recursively so that said operands are able to continually change in response to said events.

17. The method of claim 14 further including the step of organizing the surveillance system into layers, wherein a physical layer includes physical components of the system, a utility layer includes utility algorithms of the system, an abstraction layer includes abstraction processes of the system, an application layer includes applications of the system, and a management/control layer includes a control means for the system.

18. The method of claim 17 further including the step of providing both off-the-shelf algorithms and system-specific algorithms in said utility layer for performing utility operations on and controlling the gathering of said surveillance data by said surveillance devices.

19. The method of claim 17 further including the step of providing processes in said abstraction layer for performing spatio-temporal processing of said surveillance data.

20. The method of claim 17 further including the step of providing a graphic user interface in said application layer for interfacing with a user for configuring the surveillance system.

21. The method of claim 20 further including the step of the user operating said graphic user interface to manually configure said operands and said profiles.

22. The method of claim 17 further including the step of providing a data mining application in said application layer for extracting data from said database for obtaining extracted data and relating said extracted data with said surveillance data for producing an automated response to said event.

23. The method of claim 17 further including the step of providing an analysis application in said application layer for performing at least one analysis operation on said surveillance data, said analysis operation being chosen from real-time analysis, statistical analysis, and trend analysis.

24. An automatically adaptive surveillance system for operating in a surveillance environment, said system comprising:
at least one surveillance device located within the surveillance environment, said surveillance device having controllable operation parameters, said surveillance device further being capable of producing surveillance data;
a controller in communication with said at least one surveillance device for providing pre-configured control operands for controlling said operation parameters of said surveillance device;
a relational database containing information, said database being in communication with said controller; and
said controller further including pre-configured event-detection operands for examining said surveillance data delivered from said surveillance device and comparing said at least one surveillance data with said information in said relational database for determining if an event has occurred, whereby if an event has occurred, said control operands are automatically reconfigured for adapting said at least one surveillance device in response to said event.

25. The system of claim 24, wherein said reconfiguration of said control operands takes place in real-time.

26. The system of claim 24, wherein said pre-configured event-detection operands are reconfigured in response to said event to produce reconfigured event-detection operands.

27. The system of claim 26 wherein said reconfiguration of said pre-configured event-detection operands takes place recursively, so that said reconfigured event-detection operands are capable of further self-reconfiguration.

28. The system of claim 26 wherein said reconfiguration of said event-detection operands takes place in real-time.

29. The system of claim 26 wherein said event-detection operands include a recognition function for recognizing a predetermined characteristic of interest.

30. The system of claim 29 wherein said surveillance data includes digital images, and said recognition function is a recognition application for recognizing features contained in said digital images and comparing said features with said information contained in said database for determining if said digital images contain said predetermined characteristic of interest.

31. The system of claim 30 wherein said recognition application is a facial recognition application for recognizing and identifying the faces of people in the surveillance environment.

32. The system of claim 30 wherein said recognition application is a vehicle license plate recognition application for recognizing and identifying license plates on vehicles in the surveillance environment.

33. The system of claim 30 wherein said recognition application is a human/vehicle interaction recognition application for recognizing and identifying unordinary human/vehicle interaction in the surveillance environment.

34 The system of claim 29 wherein said surveillance data includes digital surveillance sensor data, and said recognition function is a recognition application for recognizing features and patterns contained in said digital surveillance sensor data and comparing said features and patterns with said information contained in said database for determining if said digital surveillance sensor data contains said predetermined characteristic of interest.

35. The system of claim 24 wherein the surveillance system is organized to comprise a physical layer including physical components of the system, a utility layer including utility algorithms of the system, an abstraction layer including abstraction processes of the system, an application layer including applications of the system, and a management/control layer including a control means for the system.

36. The system of claim 24 further including both off-the-shelf and system-specific algorithms for performing utility operations on and controlling the operation of said at least one surveillance device for producing said surveillance data.

37. The system of claim 24 further including processes for performing spatio-temporal processing of said surveillance data.

38. The system of claim 24 further including a graphic user interface for enabling a user to configure the surveillance system.

39. The system of claim 38 wherein the user can operate said graphic user interface to manually configure said pre-configured control operands and said pre-configured event-detection operands.

40. The system of claim 24 further including a data mining application for extracting data from said database for obtaining extracted data and relating said extracted data with said surveillance data for producing an automated response.

41. The method of claim 24 further including an analysis application for performing at least one analysis operation on said surveillance data, said analysis operation being chosen from real-time analysis, statistical analysis, and trend analysis.

42. An automatically adaptive surveillance system for operating in a surveillance environment, said system comprising:
a physical layer including a plurality of surveillance devices for gathering surveillance data from the environment;
a utility layer including algorithms for performing utility operations on and controlling the operation of said surveillance devices;
an abstraction layer including processes for processing the surveillance data gathered by the surveillance devices and determining whether an event has occurred;
an application layer including a graphic user interface for enabling a user to configure the system; and
a management/control layer for automatically controlling and coordinating the operation of the system.

43. The system of claim 42 further including a relational database containing information, said database being in communication with said management/control layer, said management/control layer further including pre-configured control operands provided to said utility layer for controlling said surveillance devices, said management/control layer further including pre-configured event-detection operands provided to said abstraction layer for examining said surveillance data and comparing said surveillance data with said information in said relational database for determining if an event has occurred, whereby if an event has occurred, said control operands are reconfigured for adapting said surveillance devices in response to said event.

44. The system of claim 43 wherein said event-detection operands are reconfigured in response to said event.
